(19) United States
(12) Patent Application Publication
(10) Pub. No.: US 2020/0169954 A1
(43) Pub. Date: May 28, 2020

(54) ACCESS POINT APPARATUS, STATION APPARATUS, AND COMMUNICATION METHOD

(71) Applicant: SHARP KABUSHIKI KAISHA, Sakai City, Osaka (JP)

(72) Inventors: HIDEO NAMBA, Sakai City, Osaka (JP); HIROMICHI TOMEBA, Sakai City, Osaka (JP)

(21) Appl. No.: 16/608,102

(22) PCT Filed: Apr. 19, 2018
(86) PCT No.: PCT/JP2018/016166

§ 371 Date: Oct. 24, 2019

(30) Foreign Application Priority Data
Apr. 28, 2017 (JP) 2017-089789

(51) Int. Cl. H04W 52/02; H04W 72/04; H04W 52/32; H04W 4/06

(52) U.S. Cl. CPC H04W 52/0216; H04W 72/0446; H04W 74/0808; H04W 4/06; H04W 52/0229; H04W 52/327

(57) ABSTRACT

An access point transmits information relating to total power or power density of an L-part and a WUR-part to a station. The station transmits information relating to a WUR-part reception capability to the access point. The station causes a counter field to be included in a WU radio frame at the time of performing multicast transmission of a WU radio signal a plurality of times, and configures a value corresponding to the number of transmission times in the counter field.

### TECHNICAL FILED

The present invention relates to an access point apparatus, a station apparatus, and a communication method.

This application claims priority based on JP 2017-089789 filed on Apr. 28, 2017, the contents of which are incorporated herein by reference.

### BACKGROUND

In recent years, a radio communication system that includes at least a self-supporting terminal apparatus and a base station apparatus that can be relatively freely used has been advanced in use, and has been used in various applications in various forms including a so-called wireless LAN. In particular, the wireless LAN has low difficulty of introduction, is applicable to both a network form that secures connection to the Internet and a network form that is isolated from the outside, and is used for wide use. Although a communication speed of the wireless LAN was approximately 1 Mbps at the beginning of its spread, the speed increases with advances in technology, and the total throughput of communication data in a base station apparatus exceeds 1 Gbps (NPL 1 and NPL 2).

On the other hand, unlike the wireless LAN, use of a radio communication system that focuses on reducing power consumption of a terminal apparatus rather than increasing the communication speed is also advanced. Examples of such a radio communication system include Bluetooth (registered trademark), ZIGBEE (registered trademark), and the like, and is used mainly in a system that uses a battery as a power source.

### CITATION LIST

### Non Patent Literature

NPL 1: IEEE std 802.11-2012

NPL 2: IEEE std 802.11ac-2013

NPL 3: IEEE P802.11, A PAR Proposal for Wake-up radio

### SUMMARY OF INVENTION

### Technical Problem

However, as the spread of the wireless LAN progresses, demand for introducing the wireless LAN into an apparatus that uses the battery as the power source increases. Although, in the existing wireless LAN, a power-saving operation for increasing standby time is defined, the only way to reduce the power consumption is to increase the standby time, this means increase in waiting time until communication becomes possible in a case that communication data occur, that is, latency, and causes a significant decrease in user experience.

Although efforts have been made to achieve the low power consumption and reduction in the standby time by adding a radio function operating at low power to a physical layer of the wireless LAN and using this added radio function during the standby time (NPL 3), newly generated overhead and adverse influence on the existing wireless LAN cannot be resolved. An aspect of the present invention has been made in view of such circumstances, is to reduce overhead and reduce influence on the existing wireless LAN, and an object of the present invention is to provide comfortable user experience.

### Solution to Problem

In order to accomplish the object described above, according to an aspect of the present invention, provided is an access point apparatus including: a transmission RF unit configured to transmit a wireless LAN signal and a wake-up radio signal, in which the wake-up radio signal includes a legacy part and a wake-up radio part, a band of a signal of the legacy part and a band of a signal of the wake-up radio part are different from each other, a wake-up radio frame included in the wake-up radio signal includes an identifier for indicating being multicast transmission, and the wake-up radio signal that includes a predetermined number of the wake-up radio frames is transmitted in a radio medium time secured by a carrier sense.

Furthermore, according to another aspect of the present invention, provided is the access point apparatus in which a counter field may be included in the wake-up radio frame, the predetermined number may be configured in the counter field at a time of initial transmission of the wake-up radio signal, and a value of the counter field may be decreased every time the wake-up radio signal is transmitted a plurality of times.

Furthermore, according to another aspect of the present invention, provided is the access point apparatus in which, after the wake-up radio signal that includes the predetermined number of the wake-up radio frames is transmitted, a trigger frame for causing a plurality of station apparatuses that are destinations of the multicast transmission to respond may be transmitted after a first time has elapsed, and the first time may be based on the value configured in the counter field of the wake-up radio frame.

Furthermore, according to another aspect of the present invention, provided is the access point apparatus in which an identifier for indicating being unicast transmission may further be included, or the identifier for indicating the multicast transmission may indicate the unicast transmission in a case of not indicating the multicast transmission, and a length of at least one field of the counter field and another field included in the wake-up radio frame may change between a time of the unicast transmission and a time of the multicast transmission.

Furthermore, according to another aspect of the present invention, provided is the access point apparatus in which a sequence number may be included in the wake-up radio frame transmitted by the access point apparatus.

Furthermore, according to another aspect of the present invention, provided is a station apparatus including: a reception RF unit configured to receive a wireless LAN signal and a wake-up radio signal, in which the wake-up radio signal includes a legacy part and a wake-up radio part, a band of a signal of the legacy part and a band of a signal of the wake-up radio part are different from each other, the wake-up radio signal includes a wake-up radio frame, the wake-up radio frame includes an identifier for indicating being multicast transmission, and in a case that the wake-up radio frame that indicates being the multicast transmission by using the identifier for indicating being the multicast transmission is received, a trigger frame is transmitted to the access point at a first time indicated by a value of a counter frame included in the wake-up radio frame.

Furthermore, according to another aspect of the present invention, provided is the station apparatus in which the wake-up radio frame that is received may include a sequence number, and in a case of receiving the wake-up radio frame that includes a sequence number that overlaps with a sequence number included in the wake-up radio frame that is previously received, the wake-up radio frame that includes the sequence number that overlaps may be discarded.

Furthermore, according to another aspect of the present invention, provided is the station apparatus in which a field length of a counter field and another field included in each of the wake-up radio frame that indicates being the multicast transmission and the wake-up radio frame that does not indicate being the multicast transmission, by using the identifier for indicating being the multicast transmission, may change between a time of the multicast transmission and a time of transmission other than the multicast transmission.

Furthermore, according to another aspect of the present invention, provided is a station apparatus including: a reception RF unit configured to receive a wireless LAN signal and a wake-up radio signal, in which the wake-up radio signal includes a legacy part and a wake-up radio part, a band of a signal of the legacy part and a band of a signal of the wake-up radio part are different from each other, and any one or both of total power and power density are individually configured for each of the signal of the legacy part and the signal of the wake-up radio part.

Furthermore, according to another aspect of the present invention, provided is the station apparatus in which, to an access point that is a connection destination, information including at least one of a band, total power, or power density of a wake-up radio signal that the station apparatus is capable of receiving may be transmitted.

Furthermore, according to another aspect of the present invention, provided is an access point apparatus including: a transmission RF unit configured to transmit a wireless LAN signal and a wake-up radio signal to the station apparatus, in which the wake-up radio signal includes a legacy part and a wake-up radio part, a band of a signal of the legacy part and a band of a signal of the wake-up radio part are different from each other, and any one or both of total power and power density are individually configured for each of the signal of the legacy part and a signal of a wake-up part.

Furthermore, according to another aspect of the present invention, provided is the access point apparatus in which information relating to the total power or the power density of each of the legacy part and a wake-up radio of the wake-up radio signal to be transmitted to the station apparatus may be transmitted to the station apparatus.

Furthermore, according to another aspect of the present invention, provided is the access point apparatus in which, from the station apparatus, information including at least one of a band, total power, or power density of the wake-up radio signal that the station apparatus is capable of receiving may be received.

Furthermore, according to another aspect of the present invention, provided is a communication method including the step of: transmitting a wireless LAN signal and a wake-up radio signal, in which the wake-up radio signal includes a legacy part and a wake-up radio part, a band of a signal of the legacy part and a band of a signal of the wake-up radio part are different from each other, a wake-up radio frame is included at a time of transmitting the wake-up radio signal, the wake-up radio frame includes an identifier for indicating being multicast transmission and a counter field, in a case that the wake-up radio signal that includes a predetermined number of the wake-up radio frames is transmitted in a radio medium time secured by a carrier sense, a value of the counter field is decreased every time the wake-up radio signal is transmitted, after the wake-up radio signal that includes the predetermined number of the wake-up radio frames is transmitted, a trigger frame for causing the plurality of station apparatuses that are destinations of the multicast transmission to respond is transmitted after a first time has elapsed, and the first time is based on the value configured in the counter field of the wake-up radio frame.

### Advantageous Effects of Invention

According to an aspect of the present invention, by reducing overhead due to deterioration of reception characteristics caused by a difference in power density between a legacy part and a WU radio part included in a WU radio signal and overhead generated at a time of multicast transmission of the WU radio signal, it is possible to improve user experience.

### BRIEF DESCRIPTION OF DRAWINGS

FIG. 1 is a diagram illustrating an apparatus configuration example according to an embodiment of the present invention.

FIG. 2 is a diagram illustrating a PPDU configuration of the IEEE802.11ac standard.

FIG. 3 is a diagram illustrating an example of L-SIG Dulation.

FIG. 4 is a diagram illustrating examples of frequency resource division.

FIG. 5 is a diagram illustrating examples of a configuration of a PPDU transmitted by a radio communication apparatus.

FIG. 6 is a diagram illustrating an apparatus configuration example according to an embodiment of the present invention.

FIG. 7 is a diagram illustrating a configuration example of a WU radio frame according to an embodiment of the present invention.

FIG. 8 is a diagram illustrating configuration examples of a WU radio frame according to an embodiment of the present invention.

FIG. 9 is a diagram illustrating allocation examples of a WU radio channel according to an embodiment of the present invention.

FIG. 10 is a diagram illustrating a configuration example of a WU radio frame according to an embodiment of the present invention.

FIG. 11 is a diagram illustrating a sequence chart illustrating an operation overview according to an embodiment of the present invention.

FIG. 12 is a block diagram illustrating an example of a configuration of a station used in an embodiment of the present invention.

FIG. 13 is a block diagram illustrating an example of a configuration of a station used in an embodiment of the present invention.

FIG. 14 is a diagram illustrating examples of a configuration of a WU radio signal used in an embodiment of the present invention.

FIG. 15 is a diagram illustrating examples of a configuration of a WU radio frame used in an embodiment of the present invention.

FIG. 16 is a flowchart illustrating an operation overview of a station according to an embodiment of the present invention.

### DESCRIPTION OF EMBODIMENTS

Hereinafter, a radio communication technology according to embodiments of the present invention will be described in detail with reference to the drawings.

A communication system according to the present embodiment includes a radio transmission apparatus (access point, base station apparatus: access point, base station apparatus, access point apparatus), and multiple radio reception apparatuses (stations, terminal apparatuses: stations, terminal apparatuses, station apparatuses). Furthermore, a network including the base station apparatus and the terminal apparatus is referred to as a Basic service set (BSS, management range). Furthermore, the base station apparatus and the terminal apparatus are also collectively referred to as a radio apparatus.

Each of the base station apparatus and the terminal apparatus in the BSS is assumed to perform communication based on Carrier sense multiple access with collision avoidance (CSMA/CA). A target of the present embodiment is an infrastructure mode in which the base station apparatus communicates with multiple terminal apparatuses, but the method of the present embodiment can also be implemented in an ad hoc mode in which the terminal apparatuses perform direct communication with each other. In the ad hoc mode, the terminal apparatus replaces the base station apparatus and forms the BSS. The BSS in the ad hoc mode is also referred to as an Independent Basic Service Set (IBSS). Hereinafter, the terminal apparatus forming the IBSS in the ad hoc mode can also be regarded as the base station apparatus.

In the IEEE802.11 system, each apparatus can transmit transmission frames of multiple frame types with a common frame format. The transmission frames are individually defined in a Physical (PHY) layer, a Medium access control (MAC) layer, and a Logical Link Control (LLC) layer.

The transmission frame of the PHY layer is referred to as a physical protocol data unit (PHY protocol data unit (PPDU), physical layer frame). The PPDU includes a physical layer header (PHY header) including header information for performing signal processing in the physical layer and the like, a physical service data unit (PHY service data unit (PSDU), MAC layer frame) which is a data unit processed in the physical layer, and the like. The PSDU can include an Aggregated MPDU (A-MPDU) in which multiple MAC protocol data units (MPDUs) to serve as a retransmission unit in a radio section are aggregated.

The PHY header includes a reference signal such as a Short training field (STF) used for detection, synchronization, or the like of a signal, a Long training field (LTF) used for obtaining channel information for data demodulation, or the like, and a control signal such as a Signal (SIG) including control information for data demodulation or the like. Furthermore, the STF is classified, in accordance with a supporting standard, into a Legacy-STF (L-STF), a High throughput-STF (HT-STF), a Very high throughput-STF (VHT-STF), a High efficiency-STF (HE-STF), and the like, and the LTF and the SIG are also respectively classified, in the same manner, into an L-LTF, an HT-LTF, a VHT-LTF, and an HE-LTF, and an L-SIG, an HT-SIG, a VHT-SIG, and an HE-SIG. The VHT-SIG is further classified into a VHT-SIG-A1, a VHT-SIG-A2, and a VHT-SIG-B. In the same manner, the HE-SIG is classified into HE-SIG-A1 to 4 and an HE-SIG-B.

Furthermore, the PHY header can include information for identifying the BSS of a transmission source of the transmission frame (hereinafter, also referred to as BSS identification information). The information for identifying the BSS can be, for example, a Service Set Identifier (SSID) of the BSS or a MAC address of the base station apparatus of the BSS. Furthermore, the information for identifying the BSS can be a BSS specific value (e.g., BSS Color, or the like) other than the SSID and the MAC address.

The PPDU is modulated in accordance with the supporting standard. For example, in a case of the IEEE802.11n standard, modulation to the Orthogonal frequency division multiplexing (OFDM) signal is performed. For example, in a case of the IEEE802.11ad standard, modulation to a single carrier signal can also be performed.

The MPDU includes an MAC layer header (MAC header) including header information for performing signal processing in the MAC layer and the like, an MAC service data unit (MSDU), which is a data unit processed in the MAC layer, or a frame body, and a frame check unit (Frame check sequence (FCS)) for checking whether or not the frame contains errors. Furthermore, multiple MSDUs can also be aggregated as an Aggregated MSDU (A-MSDU).

Frame types of the MAC layer transmission frame are roughly classified into three frames of a management frame for managing an association state between the apparatuses or the like, a control frame for managing a communication state between the apparatuses, and a data frame including actual transmission data, and each type is further classified into multiple subframe types. The control frame includes a reception completion notification (Acknowledge (Ack)) frame, a transmission request (Request to send (RTS)) frame, a reception preparation completion (Clear to send (CTS)) frame, and the like. The management frame includes a Beacon frame, a Probe request frame, a Probe response frame, an Authentication frame, an Association request frame, an Association response frame, and the like. The Data frame includes a Data frame, a polling (CF-poll) frame, and the like. By reading contents of a frame control field included in the MAC header, each apparatus can obtain the frame type and the subframe type of the received frame.

Note that the Ack may include a Block Ack. The Block Ack is capable of performing a reception completion notification for the multiple MPDUs.

The beacon frame includes a Field in which a cycle in which the beacon is transmitted (Beacon interval) and the SSID are written. The base station apparatus can cyclically broadcast the beacon frame in the BSS, and the terminal apparatus can grasp, by receiving the beacon frame, the base station apparatus around the terminal apparatus. Grasping the base station apparatus by the terminal apparatus based on the beacon frame broadcast by the base station apparatus is referred to as Passive scanning. On the other hand, probing the base station apparatus by the terminal apparatus that broadcasts the probe request frame in the BSS is referred to as Active scanning. The base station apparatus can transmit the probe response frame as a response to the probe request frame, and the contents written in the probe response frame is equivalent to that of the beacon frame.

After recognizing the base station apparatus, the terminal apparatus performs association processing on the base station apparatus. The association processing is classified into an Authentication procedure and an Association procedure. The terminal apparatus transmits an authentication frame (authentication request) to a base station apparatus with which the terminal apparatus desires to establish the association. In a case of receiving the authentication frame, the base station apparatus transmits, to the terminal apparatus, the authentication frame (authentication response) including a status code indicating whether or not the authentication is allowed for the terminal apparatus or the like. The terminal apparatus can determine whether or not the authentication of the apparatus itself is allowed by the base station apparatus by reading the status code written in the authentication frame. Note that the base station apparatus and the terminal apparatus are capable of exchanging authentication frames multiple times.

Following the authentication procedure, the terminal apparatus transmits an association request frame in order to perform an association procedure to the base station apparatus. In a case of receiving the association request frame, the base station apparatus determines whether or not to allow the association of the terminal apparatus, and transmits the association response frame for notification of the determination. In the association response frame, in addition to the status code indicating whether or not the association process is allowed, an association identification number (Association identifier (AID)) for identifying the terminal apparatus is written. The base station apparatus can manage the multiple terminal apparatuses by configuring different AID for each terminal apparatus whose association therewith has been allowed.

After the association processing is performed, the base station apparatus and the terminal apparatus perform actual data transmission. In the IEEE802.11 system, a Distributed Coordination Function (DCF) and a Point Coordination Function (PCF), and expanded functions of these (Enhanced distributed channel access (EDCA), Hybrid coordination function (HCF), and the like) are defined. Descriptions will be given below by taking a case that the base station apparatus transmits a signal to the terminal apparatus by the DCF as an example.

In the DCF, prior to communication, the base station apparatus and the terminal apparatus perform Carrier sense (CS) for confirming a use situation of a radio channel around the apparatus itself. For example, in a case of receiving a signal with a higher level than a predetermined Clear channel assessment level (CCA level) on the radio channel, the base station apparatus, which is the transmission station, postpones the transmission of the transmission frame on the radio channel. Hereinafter, in the radio channel, a state in which a signal with the CCA level or higher is detected is referred to as a Busy state, and a state in which no signal with the CCA level or higher is detected is referred to as an Idle state. As described above, the CS performed based on power (received power level) of the signal actually received by each apparatus is referred to as physical carrier sense (physical CS). Note that the CCA level is also referred to as a carrier sense level (CS level) or a CCA threshold (CCAT). Note that in a case of detecting the signal with the CCA level or higher, the base station apparatus and the terminal apparatus enter into an operation of demodulating at least the signal of the PHY layer. Accordingly, the carrier sense level can also be considered as minimum reception power (minimum reception sensitivity) at which the base station apparatus and the terminal apparatus can correctly demodulate the received frame.

The base station apparatus performs the carrier sense only in an Inter frame space (IFS) depending on the type on the transmission frame to be transmitted, and determines whether the radio channel is in the busy state or the idle state. The duration during which the base station apparatus performs the carrier sense differs depending on the frame type and the subframe type of the transmission frame which will be transmitted by the base station apparatus. In the IEEE802.11 system, multiple IFSs with different durations are defined, and a short inter frame space (Short IFS (SIFS)) used for a transmission frame given the highest priority, a polling inter frame space (PCF IFS (PIFS)) used for a transmission frame with a relatively high priority, and a distributed control inter frame space (DCF IFS (DIFS)) used for a transmission frame with the lowest priority are included, and the IFS used for the transmission frame with the high priority is shorter in duration. In a case that the base station apparatus transmits a data frame by the DCF, the base station apparatus uses the DIFS. Note that in the EDCA, an Arbitration interframe space (Arbitration IFS (AIFS)) is available, and in the AIFS, for each Access category (AC) configured for the frame to be transmitted by the base station apparatus, a different duration can be configured, and the frame priority can be further flexibly configured.

After standing by for the DIFS, the base station apparatus further stands by for a random back-off time to prevent a frame collision. In the IEEE802.11 system, a random back-off time which is called a Contention window (CW) is used. In the CSMA/CA, it is assumed that the transmission frame transmitted by a certain transmission station is received by a reception station in a state where there is no interference from other transmission stations. Accordingly, in a case that the transmission stations transmit the transmission frames at the same timing, the frames collide with each other, and cannot be correctly received by the reception station. Therefore, by each of the transmission stations standing by for a time which is randomly configured before starting the transmission, the frame collision is avoided. In a case of determining that the radio channel is in the idle state by the carrier sense, the base station apparatus starts a countdown of the CW, acquires the transmission right for the first time after the CW reaches 0, and can transmit the transmission frame to the terminal apparatus. Note that in a case that the base station apparatus determines that the radio channel is in the busy state by the carrier sense during the countdown of the CW, the countdown of the CW is stopped. Then, in a case that the radio channel enters the idle state, following the previous IFS, the base station apparatus resumes the countdown of the remaining CW.

The terminal apparatus, which is the reception station, receives the transmission frame, reads the PHY header of the transmission frame, and demodulates the received transmission frame. Then, by reading the MAC header of the demodulated signal, the terminal apparatus can recognize whether or not the transmission frame is a frame addressed to the apparatus itself. Note that the terminal apparatus can determine the destination of the transmission frame based on information written in the PHY header (e.g., a group identification number (Group identifier (GID), Group ID) in which the VHT-SIG-A is written).

In a case that the received transmission frame is determined as being addressed to the apparatus itself and the transmission frame has been able to be demodulated without errors, it is necessary for the terminal apparatus to transmit the ACK frame indicating that the frame can be correctly received to the base station apparatus, which is the transmission station. The ACK frame is one of the transmission frames with the highest priority transmitted only by standing by during the SIFS duration (random back-off time is not taken). The base station apparatus terminates a series of communications in a case of receiving the ACK frame transmitted from the terminal apparatus. Note that in a case that the terminal apparatus has not been able to correctly receive the frame, the terminal apparatus does not transmit the ACK. Accordingly, in a case that the ACK frame is not received from the reception station for a constant duration (SIFS+ACK frame length) after transmitting the frame, the base station apparatus considers the communication as a failure and terminates the communication. As described above, the termination of one- time communication (also referred to as a burst) of the IEEE802.11 system is always determined by the presence or absence of the reception of the ACK frame, except for a special case such as a case of transmission of a broadcast signal such as the beacon frame or the like, a case where fragmentation is used to divide the transmission data, or the like.

The terminal apparatus configures, in a case of determining that the received transmission frame is not a frame addressed to the apparatus itself, a Network allocation vector (NAV) based on a Length of the transmission frame written in the PHY header or the like. The terminal apparatus does not attempt communication for a duration configured to the NAV. In other words, since the terminal apparatus performs the same operation as that in a case of determining that the radio channel is in the busy state by the physical CS in the duration configured to the NAV, communication control by the NAV is also referred to as virtual carrier sense (virtual CS). The NAV is also configured, in addition to a case of being configured based on the information written in the PHY header, by the transmission request (Request to send (RTS)) frame introduced to solve a hidden terminal problem or by the reception preparation completion (Clear to send (CTS)) frame.

In contrast to the DCF in which each apparatus performs the carrier sense and autonomously acquires the transmission right, in the PCF, a control station called a Point coordinator (PC) controls the transmission right of each apparatus in the BSS. In general, the base station apparatus serves as the PC and acquires the transmission right of the terminal apparatus in the BSS.

A communication period by the PCF includes a Contention free period (CFP) and a Contention period (CP). During the CP, communication is performed based on the DCF as described above, and the PC controls the transmission right during the CFP. The base station apparatus, which is the PC, broadcasts the beacon frame in which the duration of the CFP (CFP Max duration) or the like is written, in BSS, prior to PCF communication. Note that the PIFS is used for the transmission of the beacon frame broadcast at the time of the start of the transmission of the PCF, and transmission is performed without waiting for the CW. The terminal apparatus that has received the beacon frame configures the duration of the CFP written in the beacon frame to the NAV. Thereafter, until the period configured in the NAV elapses or a signal for broadcasting the termination of the CFP in the BSS (e.g., a data frame including a CF-end) is received, the terminal apparatus can acquire the transmission right only in a case that a signal for signalling the transmission right acquisition transmitted from the PC (e.g., a data frame including the CF-poll) is received. Note that during the CFP, since collision of packets within the same BSS does not occur, each terminal apparatus does not take the random back-off time used in the DCF.

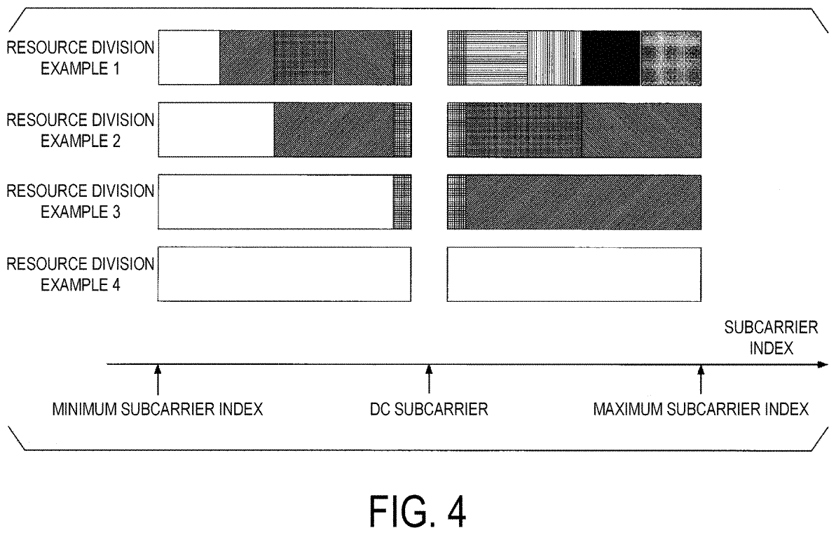

A radio medium can be divided into multiple Resource units (RUs). FIG. 4 is a schematic diagram illustrating examples of a divided state of the radio medium. For example, in a resource division example 1, the radio communication apparatus can divide a frequency resource (subcarrier), which is the radio medium, into nine RUs. In the same manner, in a resource division example 2, the radio communication apparatus can divide the subcarrier, which is the radio medium, into five RUs. As a matter of course, the resource division examples illustrated in FIG. 4 are merely examples, and for example, each of the multiple RUs can include a different number of subcarriers. Furthermore, the radio medium divided as RU can include not only the frequency resource but also a spatial resource. By allocating frames addressed to different terminal apparatuses to the respective RUs, the radio communication apparatus (e.g., AP) can transmit frames to multiple terminal apparatuses (e.g., multiple STAs) at the same time. The AP can write information (Resource allocation information) indicating the state of the division of the radio medium, as common control information, in the PHY header of the frame transmitted by the apparatus itself. Furthermore, the AP can write information (resource unit assignment information) indicating the RU in which the frame addressed to each STA is allocated, as specific control information, in the PHY header of the frame transmitted by the apparatus itself.

In addition, multiple terminal apparatuses (e.g., multiple STAs) can transmit frames at the same time by allocating the frames to the assigned RU, respectively, and transmitting. After receiving a frame (Trigger frame (TF)) including trigger information transmitted from the AP, the multiple STAs can perform frame transmission after standing by for a prescribed duration. Each STA can grasp the RU assigned to the apparatus itself based on the information written in the TF. Furthermore, each STA can acquire the RU by random access using the TF as reference.

The AP can simultaneously assign multiple RUs to one STA. The multiple RUs can include continuous subcarriers or can include discontinuous subcarriers. The AP can transmit one frame using the multiple RUs assigned to one STA, or can transmit the multiple frames by assigning them to different RUs, respectively. At least one of the multiple frames can be a frame including control information common to the multiple terminal apparatuses to which the Resource allocation information is transmitted.

To one STA, multiple RUs can be assigned by the AP. The STA can transmit one frame using the assigned multiple RUs. Furthermore, using the assigned multiple RUs, the STA can transmit the multiple frames by assigning them to different RUs, respectively. The multiple frames can be frames of different frame types.

The AP can assign multiple Associate IDs (AIDs) to one STA. The AP can respectively assign RUs to the multiple AIDs assigned to the one STA. The AP can respectively transmit different frames, using the respectively assigned RUs, to the multiple AIDs assigned to the one STA. The different frames can be frames of different frame types.

To the one STA, the multiple Associate IDs (AIDs) can be assigned by the AP. To the multiple AIDs assigned to the one STA, RUs can be assigned, respectively. The one STA can recognize all the RUs respectively assigned to the multiple AIDs assigned to the apparatus itself as RUs assigned to the apparatus itself and can transmit one frame using the assigned multiple RUs. Furthermore, the one STA can transmit multiple frames using the assigned multiple RUs. At this time, the multiple frames can be transmitted with information, written therein, indicating the AIDs associated with the RUs respectively assigned thereto. The AP can respectively transmit different frames, using the respectively assigned RUs, to the multiple AIDs assigned to the one STA. The different frames can be frames of different frame types.

Hereinafter, the base station apparatus and the terminal apparatus are also collectively referred to as a radio communication apparatus. Furthermore, information exchanged in a case that a certain radio communication apparatus communicates with another radio communication apparatus is also referred to as data. That is, the radio communication apparatus includes a base station apparatus and a terminal apparatus.

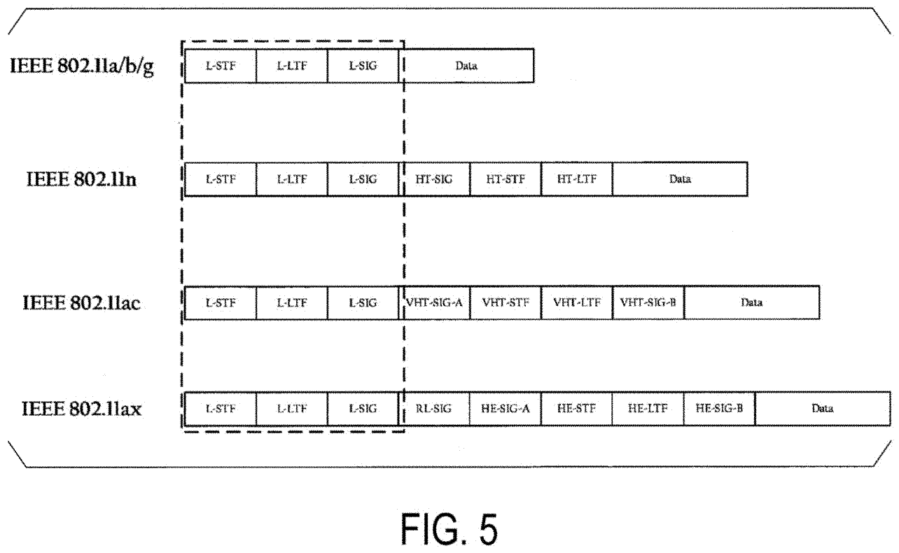

The radio communication apparatus includes any one or both of a transmission function and a reception function of the PPDU. FIG. 5 is a diagram illustrating examples of a configuration of the PPDU transmitted by the radio communication apparatus. The PPDU supporting the IEEE802.11a/b/g standards has a configuration that includes the L-STF, the L-LTF, the L-SIG, and a Data frame (MAC Frame, payload, data part, data, information bit, and the like). The PPDU supporting the IEEE802.11n standard has a configuration that includes the L-STF, the L-LTF, the L-SIG, the HT-SIG, the HT-STF, the HT-LTF, and a Data frame. The PPDU supporting the IEEE802.11ac standard has a configuration that includes some or all of the L-STF, the L-LTF, the L-SIG the VHT-SIG-A, the VHT-STF, the VHT-LTF, the VHT-SIG-B, and the MAC frame. The PPDU being discussed in the IEEE802.11ax standard has a configuration that includes some or all of the L-STF, L-LTF, L-SIG, RL-SIG in which the L-SIG is repeated in terms of time, the HE-SIG-A, the HE-STF, the HE-LTF, the HE-SIG-B, and a Data frame.

The L-STF, the L-LTF, and the L-SIG, which are surrounded by dotted lines in FIG. 5, correspond to a configuration commonly used in the IEEE802.11 standard (hereinafter, the L-STF, the L-LTF, and the L-SIG are collectively referred to as an L-header). That is, for example, a radio communication apparatus supporting the IEEE 802.11a/b/g standards can appropriately receive the L-header in the PPDU supporting the IEEE802.11n/ac standards. A radio communication apparatus supporting the IEEE 802.11a/b/g standards can receive the PPDU supporting the IEEE802.11n/ac standards while regarding it as the PPDU supporting the IEEE 802.11a/b/g standards.

However, the radio communication apparatus supporting the IEEE 802.11a/b/g standards cannot demodulate the PPDU supporting the IEEE802.11n/ac standards subsequent to the L-header, and thus cannot demodulate information relating to a Transmitter Address (TA), a Receiver Address (RA), and a Duration/ID field used for configuration of the NAV.

As a method for the radio communication apparatus supporting the IEEE 802.11a/b/g standards to appropriately configure the NAV (or perform a reception operation for a prescribed duration), the IEEE802.11 defines a method of inserting Duration information into the L-SIG. Information relating to a transmission rate in the L-SIG (RATE field, L-RATE field, L-RATE, L_DATARATE, L_DATARATE field) and information relating to the transmission duration (LENGTH field, L-LENGTH field, L-LENGTH) are used by the radio communication apparatus supporting the IEEE 802.11a/b/g standards to appropriately configure the NAV.

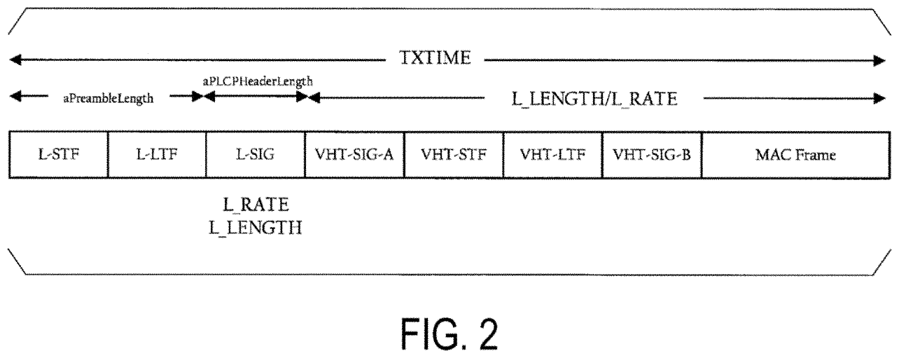

FIG. 2 is a diagram illustrating an example of a method of Duration information to be inserted into the L-SIG. In FIG. 2, although the PPDU configuration supporting the IEEE802.11ac standard is illustrated as an example, the PPDU configuration is not limited thereto. The PPDU configuration supporting the IEEE802.11n standard and the PPDU configuration supporting the IEEE802.11ax standard may be used. TXTIME includes information relating to the length of the PPDU, aPreambleLength includes information relating to the length of a preamble (L-STF+L-LTF), and aPLCPHeaderLength includes information relating to the length of a PLCP header (L-SIG). Equation (1) below is a mathematical expression illustrating an example of a calculation method for L_LENGTH.

$$\begin{matrix}Equation 1 & \\ L\_LENGTH = ⌈ \frac{\begin{matrix}( ( TXTIME - SignalExtension ) - \\ ( aPreambleLength + aPLCPHeaderLength ) )\end{matrix}}{aSymbolLength} ⌉ \times {N}_{ops} - ⌈ \frac{aPLCPServiceLength + aPLCPConvolutionalTaiLength }{8} ⌉ & ( 1 )\end{matrix}$$

Here, Signal Extension is, for example, a virtual duration configured for compatibility with the IEEE802.11 standard, and Nₒₚₛ indicates information relating to L_RATE. aSymbolLength is information relating to a duration of one symbol (symbol, OFDM symbol, or the like), aPLCPServiceLength indicates the number of bits included in a PLCP Service field, and aPLCPConvolutionalTailLength indicates the number of tail bits of a convolutional code. The radio communication apparatus can calculate the L_LENGTH using Equation (1), for example, and insert the result into the L-SIG. Note that the calculation method for L_LENGTH is not limited to Equation (1). For example, the L_LENGTH can be calculated in accordance with Equation (2) below.

$$\begin{matrix}Equation 2 & \\ L\_LENGTH = ⌈ \frac{( ( TXTIME - SignalExtension ) - 20 )}{4} ⌉ \times 3 - 3 & ( 2 )\end{matrix}$$

In a case that the radio communication apparatus transmits the PPDU by L-SIG TXOP Protection, the L_LENGTH is calculated in accordance with Equation (3) below or Equation (4) below.

$$\begin{matrix}Equation 3 & \\ L\_LENGTH = ⌈ \frac{\begin{matrix}( ( L - SIGDuration - SignalExtension ) - \\ ( aPreambleLength + aPLCPHeaderLength ) )\end{matrix}}{aSymbolLength} ⌉ \times {N}_{ops} - ⌈ \frac{aPLCPServiceLength + aPLCPConvolutionalTaiLength }{8} ⌉ & ( 3 ) \\ Equation 4 & \\ L\_LENGTH = ⌈ \frac{( ( L - SIGDuration - SignalExtension ) - 20 )}{4} ⌉ \times 3 - 3 & ( 4 )\end{matrix}$$

Here, L-SIG Duration indicates information relating to the PPDU including the L_LENGTH calculated in accordance with, for example, Equation (3) or Equation (4) and a duration obtained by summing durations of the Ack and the SIFS, which are expected to be transmitted from the destination radio communication apparatus as a response thereto. The radio communication apparatus calculates the L-SIG Duration in accordance with Equation (5) below or Equation (6) below.

Equation 5

L−SIGDuration=(T_{init_PPDU}−(aPreambleLength+aPLCPHeaderLength))+SIFS+T_{Res_PPU} (5)

Equation 6

LSIGDuration=(T_{MACDur}−SIFS−(aPreambleLength+aPLCPHeaderLength)) (6)

Here, T_{init_PPDU} indicates information relating to the duration of the PPDU including the L_LENGTH calculated in accordance with Equation (5), and the T_{Res_PPDU} indicates information relating to the duration of the PPDU of a response expected for the PPDU including the L_LENGTH calculated in accordance with Equation (5). Additionally, T_{MACDur} indicates information relating to a value of the Duration/ID field included in the MAC frame in the PPDU including the L_LENGTH calculated in accordance with Equation (6). In a case that the radio communication apparatus is an Initiator (starter, sender, leader, Transmitter), the L_LENGTH is calculated in accordance with Equation (5), and in a case that the radio communication apparatus is a Responder (answerer, recipient, Receiver), the L_LENGTH is calculated in accordance with Equation (6).

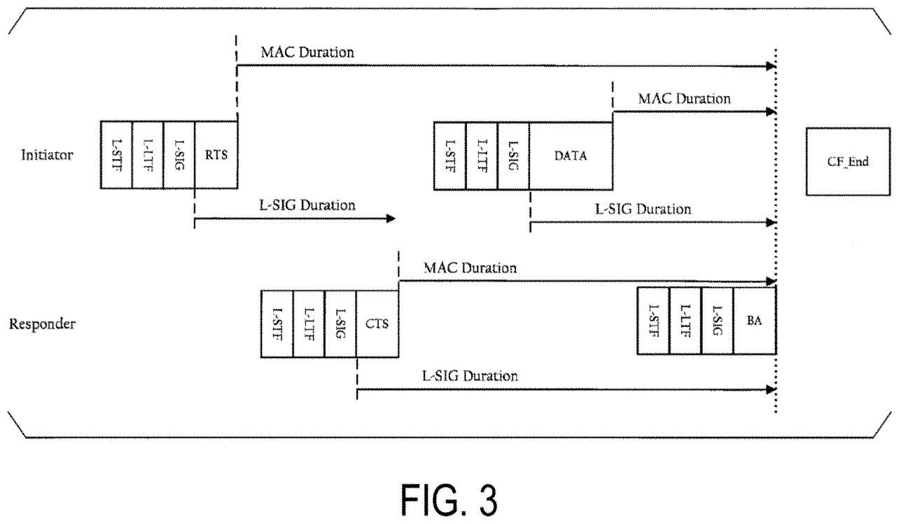

FIG. 3 is a diagram illustrating an example of the L-SIG Duration in the L-SIG TXOP Protection. DATA (frame, payload, data, or the like) includes one of or both the MAC frame and the PLCP header. Additionally, BA is the Block Ack or the Ack. The PPDU can be constituted by including the L-STF, the L-LTF, and the L-SIG, and further including any of or multiple of the DATA, the BA, the RTS, and the CTS. Although the example illustrated in FIG. 3 indicates the L-SIG TXOP Protection using the RTS/CTS, CTS-to-Self may be used. Here, the MAC Duration is a duration indicated by the value of the Duration/ID field. Additionally, the Initiator can transmit a CF_End frame to perform notification of the end of the duration of the L-SIG TXOP Protection.

Next, a method for identifying the BSS from a frame received by the radio communication apparatus will be described. In order for the radio communication apparatus to identify the BSS from the received frame, it is preferable for the radio communication apparatus that transmits the PPDU to insert information (BSS color, BSS identification information, BSS specific value) for identifying the BSS in the PPDU. The information indicating the BSS color can be written in the HE-SIG-A.

The radio communication apparatus can transmit the L-SIG multiple times (L-SIG Repetition). For example, the reception-side radio communication apparatus receives the L-SIG to be transmitted multiple times using Maximum Ratio Combining (MRC), whereby demodulation accuracy of the L-SIG is improved. Furthermore, in a case that the radio communication apparatus successfully completes the reception of the L-SIG by the MRC, it is possible to interpret the PPDU including the L-SIG as a PPDU supporting the IEEE802 .11 ax standard.

The radio communication apparatus can perform, also during reception operation of a PPDU, a reception operation of a part of a PPDU other than the PPDU (e.g., the preamble, the L-STF, the L-LTF, the PLCP header, or the like defined by the IEEE802.11) (also referred to as duplex receive operation). In a case of detecting, during the reception operation of the PPDU, a part of a PPDU other than the PPDU, the radio communication apparatus can update part of or the entire information relating to a destination address, a transmission source address, and a duration of the PPDU or the DATA.

The Ack and the BA can also be referred to as responses (response frames). Furthermore, probe response, authentication response, and association response can be referred to as response.

### First Embodiment

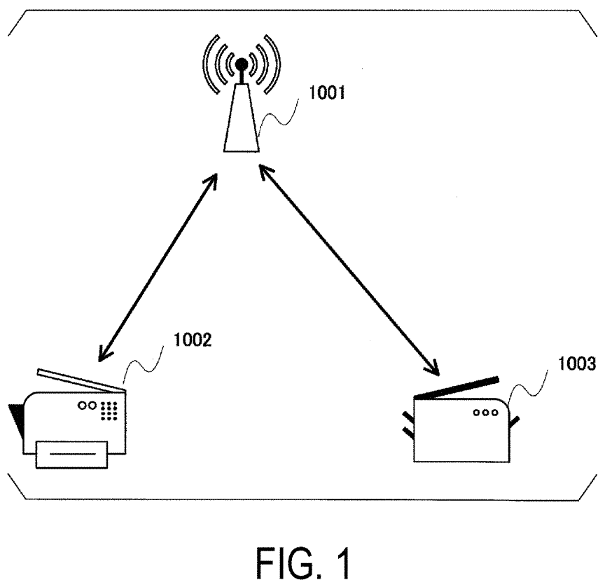

An embodiment of the present invention will be described in detail below with reference to the drawings. FIG. 1 illustrates an example of an apparatus configuration according to the present embodiment. A reference numeral 1001 denotes an access point (AP) including a wireless LAN function such as the IEEE 802.11 specification or the like as a communication method and a WU (wake-up) radio function to wake up a connected station (STA) from a sleep state, reference numerals 1002 and 1003 denote STAs that perform radio communication using a wireless LAN function and can wake up from a standby state by the WU radio function from the access point 1001. The stations 1002 and 1003 can shift, in a connected state in which communication with the access point 1001 can be performed, in a case of determining that the apparatuses are not used, in a case of determining that the radio communication is not used for a while, to a sleep state in which communication with the access point 1001 through the wireless LAN is suspended. By transmitting a WU radio packet to any one or both of the stations 1002 and 1003, the access point 1001 can release and return the station 1002 or/and 1003 from the sleep state to a connected state in which communication can be performed.

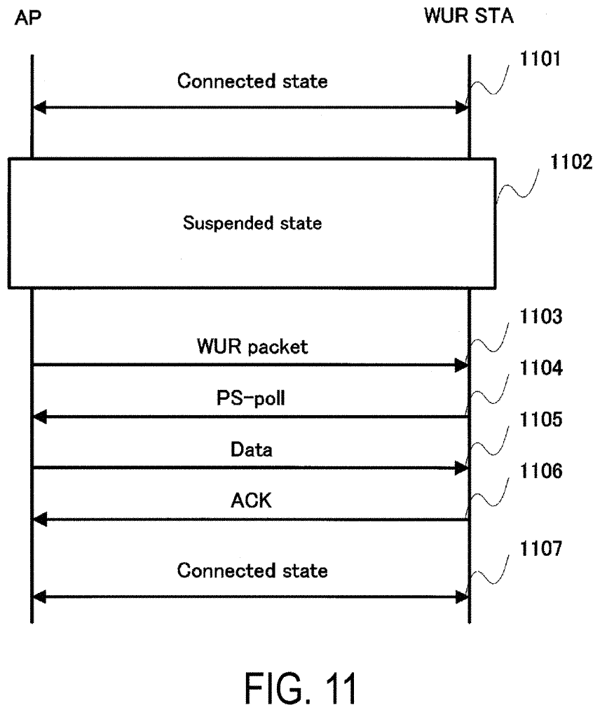

Referring to FIG. 11, an example of a process flow in which the station 1002 shifts a communication state with the access point 1001 from a connected state to a dormant state and returns to the connected state by the WU radio packet from the dormant state will be described. First, in 1101, it is assumed that a connected mode is established in which communication through the wireless LAN is performed between the access point 1001 and the station 1002. Next, in 1102, the station 1002 shifts to the dormant state, stops the wireless LAN function, and shifts to a standby mode in which only a WU radio signal (WU radio frame, WU data frame, WU frame) is received. A procedure for shifting to this standby mode is not particularly specified, but as an example, a method of automatically shifting to the standby mode in a case that time during which there is no communication at the station 1002 exceeds a prescribed time, a method of notifying the access point 1001 from the station 1002 of shifting to the standby mode, a method of requesting the station 1002 from the access point 1001 to shift to the standby mode, or the like can be used. After the station 1002 shifts to the standby mode, in a case that transmission data for the station 1002 occur at the access point 1001, the access point 1001 transmits a WU radio packet to the station 1002 in step 1103. The station 1002 having received this WU radio packet makes the wireless LAN function a usable state, then transmits a PS-poll packet to the access point 1001 in step 1104, and performs notification that data from the access point 1001 can be received. The packet transmitted at this time may not be the ps-Poll, and a packet such as an NDP packet or the like without data may be used. The access point 1001 having received this ps-Poll packet determines that the station 1002 has recovered to the connected mode and communicates with the station 1002 in step 1107.

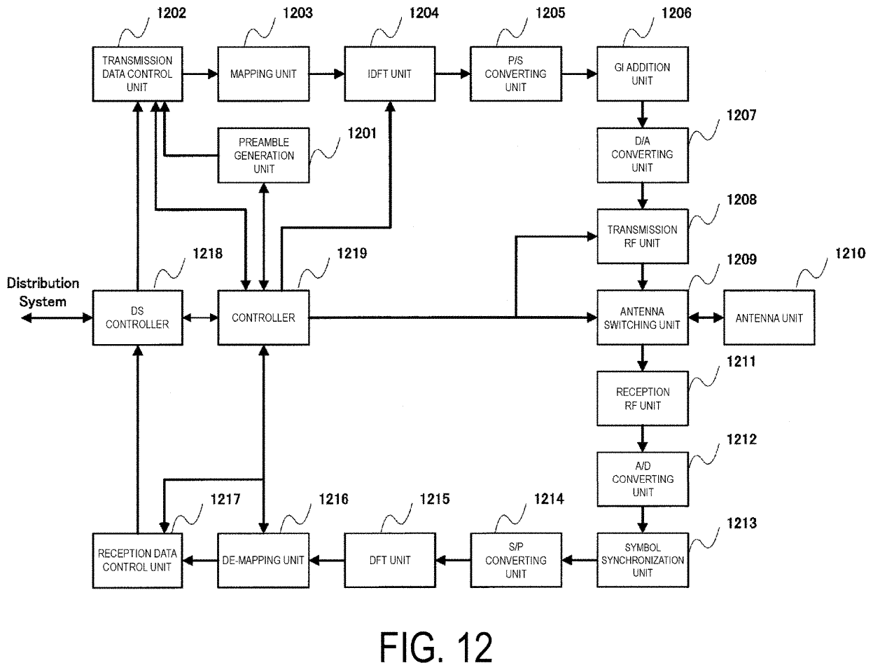

Referring to FIG. 12, an example of a configuration overview of the access point 1001 will be described. A reference numeral 1201 denotes a preamble generation unit that generates data of a preamble of a transmission packet by an indication from a controller 1219; a reference numeral 1202 denotes a transmission data control unit that generates data to be allocated in each subcarrier of the transmission packet by an indication from the controller 1219 based on the output from the preamble unit 1201 and communication data input from a DS controller 1218; a reference numeral 1203 denotes a mapping unit that configures the output from the transmission data control unit 1202 to each subcarrier of a data symbol of the transmission packet; a reference numeral 1204 denotes an IDFT unit that performs inverse discrete Fourier transform (IDFT) processing on the data configured for each subcarrier in the mapping unit 1203; a reference numeral 1205 denotes a parallel-serial (P/S) converting unit that rearranges the output of the IDFT unit 1204 in a transmission order; a reference numeral 1206 denotes a GI addition unit that adds a guard interval (GI) to the data input from the P/S converting unit 1205; a reference numeral 1207 denotes a D/A converting unit that performs digital-analog (D/A) conversion on the baseband data to which the guard interval is added in the GI addition unit 1206; a reference numeral 1208 denotes a transmission RF unit that converts the analog baseband signal input from the D/A converting unit 1207 to a signal having a frequency for transmission through an antenna unit 1210 and performs amplification to desired power; a reference numeral 1209 denotes an antenna switching unit that switches a connection destination of the antenna unit 1210 to any one of the transmission RF unit 1208 or a reception RF unit 1211; a reference numeral 1210 denotes the antenna unit through which transmission and reception of a signal with a prescribed frequency are performed; a reference numeral 1211 denotes the reception RF unit to which the signal received through the antenna unit 1210 is input via the antenna switching unit 1209 and that converts the signal to a baseband signal; a reference numeral 1211 denotes an A/D converting unit that performs analog-to-digital (A/D) conversion on the analog baseband signal input from the reception RF unit; a reference numeral 1213 denotes a symbol synchronization unit that detects a preamble from the A/D converted baseband signal, removes the guard interval in association with a symbol timing, and outputs a received signal from which the guard interval has been removed to an S/P converting unit 1214, a reference numeral 1214 denotes the P/S converting unit that parallelizes the input signal by serial-parallel (P/S) conversion and converts into a discrete Fourier transform (DFT) processible format; a reference numeral 1215 denotes a DFT unit that performs DFT processing on the input signal; a reference numeral 1216 denotes a de-mapping unit that uses the signal after the DFT processing and estimates demodulation data from a signal point of each subcarrier; a reference numeral 1217 denotes a reception data control unit that extracts a packet structure from the data after the de-mapping and checks whether or not the received packet contains an error, and outputs, in a case that there is no error, the payload of the packet to a DS controller or the controller 1219; a reference numeral 1218 denotes the DS controller that exchanges a distribution system (DS) for connecting to a network and reception data and transmission data; and a reference numeral 1219 denotes the controller that monitors the state of each block and controls each block in accordance with a predetermined procedure.

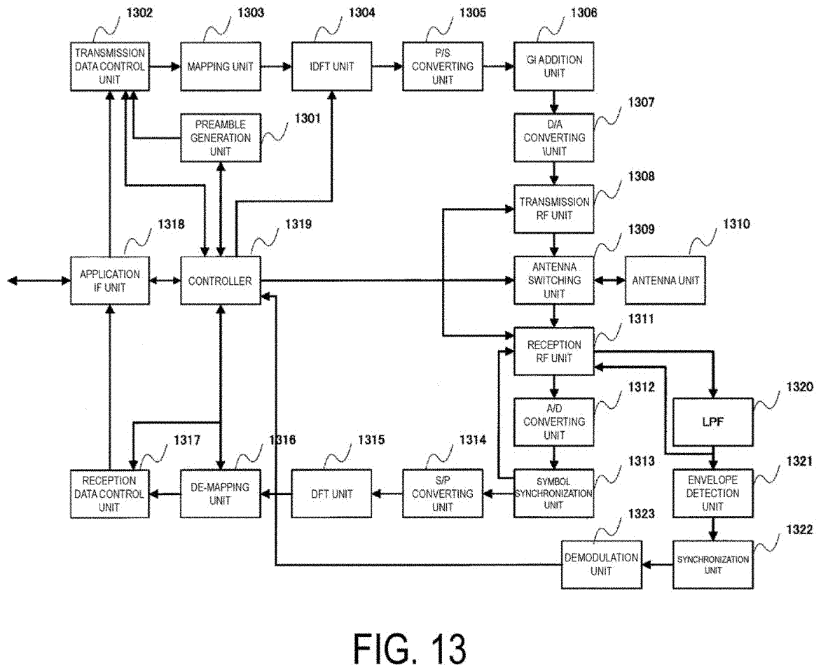

Referring to FIG. 13, an example of a configuration overview of each of the stations 1002 and 1003 will be described. The configuration overviews of the stations 1002 and 1003 are assumed to be the same. A reference numeral 1301 denotes a preamble generation unit that generates data of a preamble of a transmission packet by an indication from a controller 1319; a reference numeral 1302 denotes a transmission data control unit that generates data to be allocated in each subcarrier of the transmission packet by an indication from the controller 1319 based on the output from the preamble unit 1301 and communication data input via an application IF unit 1318; a reference numeral 1303 denotes a mapping unit that configures the output from the transmission data control unit 1302 to each subcarrier of a data symbol of the transmission packet; a reference numeral 1304 denotes an IDFT unit that performs inverse discrete Fourier transform (IDFT) processing on the data configured for each subcarrier in the mapping unit 1303; a reference numeral 1305 denotes a parallel-serial (P/S) converting unit that rearranges the output of the IDFT unit 1304 in a transmission order; a reference numeral 1306 denotes a GI addition unit that adds a guard interval (GI) to the data input from the P/S converting unit 1305; a reference numeral 1307 denotes a D/A converting unit that performs digital-analog (D/A) conversion on the baseband data to which the guard interval is added in the GI addition unit 1306; a reference numeral 1308 denotes a transmission RF unit that converts the analog baseband signal input from the D/A converting unit 1307 to a signal having a frequency for transmission through an antenna unit 1310 and performs amplification to desired power; a reference numeral 1309 denotes an antenna switching unit that switches a connection destination of the antenna unit 1310 to any one of the transmission RF unit 1308 or a reception RF unit 1311; a reference numeral 1310 denotes the antenna unit through which transmission and reception of a signal with a prescribed frequency are performed; a reference numeral 1311 denotes the reception RF unit to which the signal received through the antenna unit 1310 is input via the antenna switching unit 1309 and that converts the signal to a baseband signal; a reference numeral 1311 denotes an A/D converting unit that performs analog-to-digital (A/D) conversion on the analog baseband signal input from the reception RF unit; a reference numeral 1313 denotes a symbol synchronization unit that detects a preamble from the A/D converted baseband signal, removes the guard interval in association with a symbol timing, and outputs a received signal from which the guard interval has been removed to an S/P converting unit 1314, a reference numeral 1314 denotes the P/S converting unit that parallelizes the input signal by serial-parallel (P/S) conversion and converts into a discrete Fourier transform (DFT) processible format; a reference numeral 1315 denotes a DFT unit that performs DFT processing on the input signal; a reference numeral 1316 denotes a de-mapping unit that uses the signal after the DFT processing and estimates demodulation data from a signal point of each subcarrier; a reference numeral 1317 denotes a reception data control unit that extracts a packet structure from the data after the de-mapping and checks whether or not the received packet contains an error, and outputs, in a case that there is no error, the payload of the packet to a DS controller or the controller 1319; a reference numeral 1318 denotes the DS controller that exchanges a distribution system (DS) for connecting to a network and reception data and transmission data; a reference numeral 1320 denotes a low-pass filter (LPF) unit for extracting a signal in a band of the WU radio signal from the received baseband signal; a reference numeral 1321 denotes an envelope detection unit that performs envelope detection on the output signal of the LPF unit 1320; a reference numeral 1322 denotes a synchronization unit that detects a preamble of the WU radio signal from the output signal of the envelope detection unit 1321; a reference numeral 1323 denotes a demodulation unit that demodulates the signal subsequent to the preamble of the WU radio packet; and a reference numeral 1319 denotes the controller that monitors the state of each block and controls each block in accordance with a predetermined procedure.

In each of the connected state in which communication through the wireless LAN is performed and the standby mode state in which the function of receiving the WU radio signal is used, the stations 1002 and 1003 may control a power source state of each block constituting the stations 1002 and 1003, and optimize power consumption. As an example, in the connected state, the power consumed by the LPF unit 1320, the envelope detection unit 1321, the synchronization unit 1322, and the demodulation unit 1323 may be stopped, and in the standby mode state, it is sufficient that only the antenna switching unit 1309, the reception RF unit 1311, the LPF unit 1320, the envelope detection unit 1321, the synchronization unit 1322, the demodulation unit 1323, and the controller 1319 operate, and power consumed by other blocks may be stopped. In a case that the antenna switching unit 1309 is configured such that the antenna unit 1310 and the reception RF unit 1311 are connected in a case that the power source is not supplied, the power source to the antenna switching unit 1309 may be stopped. Additionally, the reception RF unit 1311 may be configured such that the reception RF unit 1311 consumes less power in a case of handling the WU radio signal than that in a case of handling the signal of the wireless LAN.

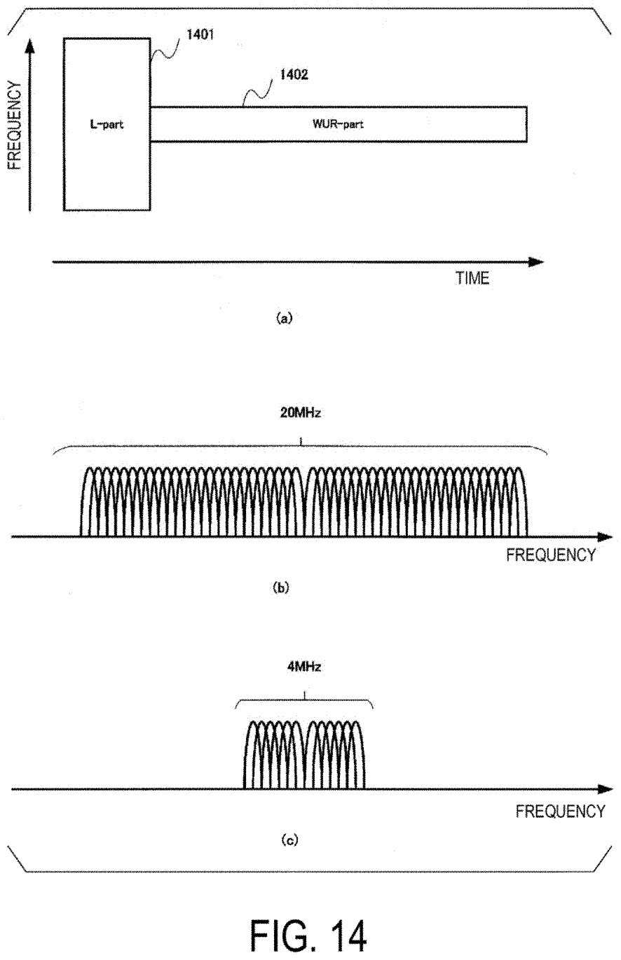

FIG. 14 illustrates examples of a configuration of the WU radio signal. In FIG. 14(a), a vertical axis indicates a frequency band occupied by the signal, and a horizontal axis indicates occupancy time in a time direction. A reference numeral 1401 denotes a legacy part (L-part) in which a signal that is compatible with the existing wireless LAN signal is used, and is a signal that can also be received by a station that cannot receive the WU radio signal. A reference numeral 1402 denotes a WU radio part (WUR-part), and is a signal for a station that can receive the WU radio signal. As illustrated in FIG. 14(a), the L-part 1401 is first transmitted and the WUR-part 1402 is subsequently transmitted. The WUR-part 1402 is narrower than the L-part 1401 in the band, and by using a signal form of a slow information speed, power used at demodulation can be reduced.

In the present embodiment, a signal of the L-part 1401 and a signal of the WUR-part 1402 are generated using the IDFT. FIG. 14(b) is a schematic diagram of a subcarrier allocation before the IDFT processing at the time of generating the L-part 1401. As an example, in a case that the number of processing points of the IDFT is 64 (an index range is taken as −32 to 31), subcarriers are allocated in a range where the index is −26 to 26, and a baseband signal after the IDFT is made to fall within a prescribed band, for example, 20 MHz. Note that an index 0 is not used as a DC (direct current) carrier. A value configured to the subcarrier at the IDFT is not particularly limited, but for example, a value used in a Short Training Field (STF), a Long Training Field (LTF), and a SIGnal (SIG) field defined by the IEEE 802.11a standard may be used. Note that the number of points of the IDFT is not limited to 64, for example, the IDFT of 128 points may be used for a 40 MHz band, or the IDFT of 256 points may be used for an 80 MHz band. In a case of using the IDFT of 128 points or 256 points, the value of the subcarriers used in a case of using the IDFT of 64 points may be replicated and a value of the desired number of points may be prepared. FIG. 14(c) is a schematic diagram of a subcarrier allocation before the IDFT processing at the time of generating the WUR-part 1402. As an example, in a case that the number of processing points of the IDFT is 64, subcarriers are allocated in a range where the index is −6 to 6, and a baseband signal after the IDFT is made to fall within, for example, 4 MHz. Note that the index 0 is not used as the DC carrier. A value configured to the subcarrier at the time of the WUR signal transmission is not particularly specified, but as an example, at the time of preamble transmission of the L-part, for example, a method using a value of a subcarrier used in the STF or the LTF of the IEEE 802.11a, a method using part of a pseudo-random number sequence such as an M sequence, or the like may be used.

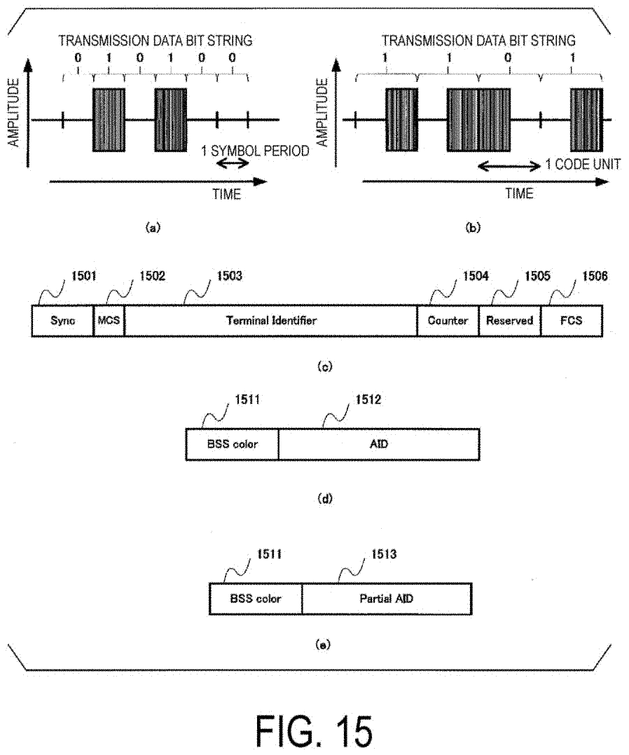

At the station on the reception side, in order to reduce power used at the time of demodulation of the WU radio signal, the WU radio signal is assumed to be in a form which can be subjected to the envelope detection. In the present embodiment, an on-off keying (OOK) modulation scheme is used. In the present embodiment, two coding types of coding with no code (no codes are used) and coding using a Manchester code are used as data coding, but one type of the coding method may be used, and more than two types may be used. An example of the WU radio signal at the time of performing the OOK modulation with no code is illustrated in FIG. 15(a). The modulation symbol uses a prescribed time as a unit, and the presence or absence of an amplitude of the WU radio signal is assigned to a transmission data bit. In the present embodiment, for the amplitude zero, the transmission bit is assumed to be zero, and for a state in which prescribed data are configured to the subcarrier used for transmission and the WU radio signal has the amplitude, the transmission bit is assumed to be one. An example of the WU signal at the time of performing the OOK modulation using the Manchester code is illustrated in FIG. 15(b). Two modulation symbols of the OOK modulation with no code are taken as one code unit, and assumed to be a modulation symbol after coding by the Manchester code. In the present embodiment, a state in which the OOK modulation symbol with no code is allocated in order of 0 and 1 is assumed as the transmission data bit 1 before the coding, and a state in which the OOK modulation symbol with no code is allocated in order of 1 and 0 is assumed as the transmission data bit 0 before the coding.

An overview of the WU radio frame structure used for the WUR-part 1402 in FIG. 14(a) is illustrated in FIG. 15(c). A reference numeral 1501 denotes a synchronization part for use in synchronization, and includes the prescribed number and values of OOK modulation symbols. For example, this synchronization part may include four OOK modulation symbols and the transmission data bits may have an allocation order of 1, 0, 1, and 0. A reference numeral 1502 denotes a field indicating a modulation scheme and coding scheme (Moduration and Coding Scheme (MCS)) of a subsequent modulation symbol, and indicates a case that the OOK modulation with no code is used using OOK modulation symbols with an allocation order of 1 and 0, and indicates a case that the OOK modulation using the Manchester code is used using OOK modulation symbols with an allocation order of 0 and 1. This is equivalent to transmitting information of 0 or 1 for identifying the MCS using the Manchester code. As a result, a terminal identifier field 1503, a counter field 1504, a reservation field 1505, and an FCS field 1506 are transmitted in the modulation scheme indicated by this MCS field 1502.

The MCS field may be omitted and notification of the MCS used by the terminal identifier field 1503, the counter field 1504, the reservation field 1505, and the FCS field 1506 may be performed by another method. As an example, multiple allocation orders of transmission data bits to be used in the synchronization part may be provided, and the notification of the MCS may be performed by using any of the multiple allocation orders, for example, in a case that an allocation order of 1, 0, 1, and 0 is used in the synchronization part, the OOK modulation using the Manchester code may be used, and in a case that an allocation order of 1, 0, 0, and 1 is used, the OOK modulation with no code may be used.

A reference numeral 1503 denotes the terminal identifier field, which includes information used to identify both or one of the access point transmitting the WU radio signal and the station receiving the WU radio signal. The information included in the terminal identifier field may not completely identify the access point or the station, and a length of the terminal identifier field may be shortened using information that may be assigned to multiple access points or multiple stations. As an example of a method for this shortening, as illustrated in FIG. 15(d), a constitution including a BSS color 1511 and an Association IDentifier (AID) 1512 may be used, or as illustrated in FIG. 15(e), a constitution including the BSS color 1511 and a shortened AID (Partial AID) 1513 may be used. The BSS color is information that is expected to be employed in the IEEE 802.11ax specification for which standardization work is currently being progressed, in which information of a shorter information length than the MAC address (48 bits), for example, a 6-bit length, is defined in order to approximately distinguish the access points, and is adjusted between the access points so as to be configured to different values as possible between access points that are present in neighborhood. The AID 1512 is an identifier, in a case that the station connects to the access point (performs Association process), assigned to the station from the access point, is information of 12-bit length in IEEE 802.11 specification, and 1 to 1023 are assigned thereto. The Partial AID 1513 is defined by the IEEE 802.11ac specification and is information of 9-bit length obtained by shortening the AID by a prescribed method. The AID 1512 and the Partial AID 1513 are information shorter than the MAC addresses (48 bits), and in a case that multiple access points are operated in the vicinity, there is a possibility that they overlap between stations connected to respective access points. Also, there is a possibility that the Partial AID 1513 overlaps between multiple stations that are connected to one access point. Processing in a case that the information of this terminal identifier field 1503 overlaps among multiple stations will be described later.

A reference numeral 1504 denotes a counter field, and is used in retry processing and reconnection processing. As an example, a 4-bit length counter may be used, and all bits thereof may be configured to 0 at the time of initial transmission of the WU radio signal. A reference numeral 1505 denotes the reservation field and is used at the time of function addition. A field length is not particularly specified, but as an example, the reservation field 1505 of 4-bit may be provided. The reservation field 1505 may be omitted in a case that the function addition is not performed in the future. A reference numeral 1506 denotes a Frame Check Sequence (FCS) field, includes a value for verifying whether or not reception data included from the terminal identifier field 1503 to the reservation field 1505 are correct, and as an example, Cyclic Redundancy Check (CRC) code, for example, CRC-8 in which a length of the generating polynomial is 9 bits, may be used.

Each of the stations 1002 and 1003 in the standby mode state for receiving the WU radio signal determines, by detecting that the output power of the LPF unit 1320 changes from a state of being below a prescribed threshold to a state of being above the prescribed threshold, that the L-part 1401 is received, and starts, by checking that the synchronization unit 1322 changes the output of the envelope detection unit 1321 as the allocation order of the data bits used in the synchronization part 1501, for example, 1, 0, 1, and 0, demodulation of the WU radio signal frame. The station that has detected the synchronization part 1501 receives the subsequent MCS field 1502, and estimates the MCS of the fields after the MCS field 1502. Each of these stations 1002 and 1003 utilizes this estimated result to demodulate the subsequent fields. Each of these stations 1002 and 1003 demodulates all of the terminal identifier field 1503, the counter field 1504, the reservation field 1505, and the FCS field 1506, utilizes the value in the FCS field 1506 to determine whether or not the terminal identifier field 1503, the counter field 1504, and the reservation field 1505 have been able to be correctly demodulated, and in a case that it can be determined that they have been able to be correctly demodulated, determines whether or not the terminal identifier field 1503 specifies the station itself. In a case that the terminal identifier field 1503 includes a value specifying the station itself, a power source is supplied to a block for communication using the wireless LAN signal of each of these stations 1002 and 1003 and a state in which communication using the wireless LAN signal can be performed is recovered. After the state in which communication using the wireless LAN signal can be performed is obtained, each of these stations 1002 and 1003 transmits a packet, for example, the ps-Poll packet, that is notification of wake-up to the access point 1001 and prompts the access point 1001 to transmit data to the station itself. Note that after receiving the MCS field 1502, at the time of receiving the terminal identifier field 1503, the value of the terminal identifier field 1503 may be checked without waiting for reception of the FCS field 1506, in a case that the value is not a value corresponding to the station itself, subsequent demodulation processing may be stopped, and the power consumption of the demodulation unit 1323 may be reduced until the next WU radio signal is detected. At this time, instead of checking all of the values in the terminal identifier field 1503, a value of a portion initially transmitted in the terminal identifier field 1503, for example, the BSS color 1511, may be checked, and the subsequent demodulation may be stopped in a case that the value is not a value corresponding to the station itself.

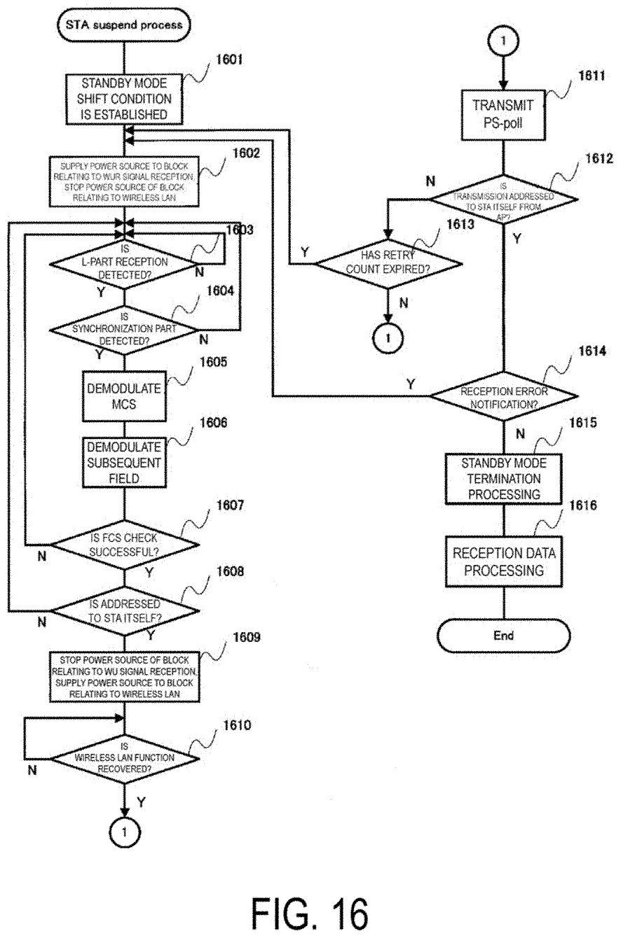

An overview of a series of processing in the standby mode of each of the stations 1002 and 1003 will described using the flowchart of FIG. 16. First, in step 1601, in a case that a shift condition to the standby mode is established, each of the stations 1002 and 1003 supplies the power source to the multiple blocks for receiving the WU radio signal and stops the power source of the multiple blocks for receiving the wireless LAN signal. In this state, in step 1603, it is determined whether or not the signal of the L-part 1401 has been detected, and, in a case that the signal was not detected, step 1603 is repeated. In a case of detecting the signal of the L-part 1401, at step 1604, whether or not the synchronization part 1501 is included in the subsequent signal is detected, and the process returns to step 1603 in a case that the detection fails, and the process proceeds to step 1605 in a case that the detection is successful. In step 1605, the MCS field 1502, which follows the synchronization part 1501, is demodulated, and furthermore, it is determined how to demodulate the subsequent field. Then, in step 1606, all fields after the MCS field 1502 are demodulated. In next step 1607, the MCS field 1502 and subsequent fields are verified using the value in the FCS field 1506, the process proceeds to step 1608 in a case that this verification is successful, and the process proceeds to step 1603 in a case of failure. In step 1608, it is determined whether or not the value of the terminal identifier field 1503 indicates the station itself, the process returns to step 1603 in a case that the value of the terminal identifier field 1503 does not indicate the station itself, and the process proceeds to step 1609 in a case that the value of the terminal identifier field indicates the station itself. In step 1609, the power source supply to the block for receiving the WU radio signal is stopped and the block for using the wireless LAN signal is supplied with the power source. Next, recovery of the function of the block, which is supplied with the power source in step 1610, for using the wireless LAN signal is waited, and in a case that the recovery is confirmed, the process proceeds to step 1611. In step 1611, each of the stations 1002 and 1003 transmits the PS-poll packet to the access point 1001. Subsequently, in step 1612, it is determined whether or not transmission is made to each of the stations 1002 and 1003 itself from the access point 1001 for the PS-poll, the process proceeds to step 1613 in a case that it is determined that there is no transmission to each of the stations 1002 and 1003 itself, and the process proceeds to step 1614 in a case that it is determined that there is transmission to the station itself. In step 1613, it is determined whether or not the number of retransmission times of the PS-poll packet has expired, in a case of expiration, by assuming that the communication with the access point 1001 through the wireless LAN signal cannot be performed for some reason, in order for configuration to the standby state again, the process proceeds to step 1602, and in a case that the number of retransmission times has not expired, the process proceeds to step 1611 and the PS-poll packet transmission is performed again. In step 1614, it is determined whether or not the signal received from the access point 1001 is a reception error notification of the WU radio signal, and in a case of the reception error notification, the process proceeds to step 1602 and the state is returned to the standby state again, and in a case that the signal is not the reception error notification, the process proceeds to step 1615. This situation of receiving the reception error notification from the access point 1001 means that the same value of the terminal identifier field 1503 as each of the stations 1002 and 1003 itself is used by another station in the vicinity that utilizes the WU radio signal. In order to solve the state as described above, before returning to step 1602, each of the stations 1002 and 1003 may receive reassignment of the value used as the terminal identifier field 1503 by exchanging information with the access point 1001. At this time, reassignment of the AID 1512 and the Partial AID 1513 may be received. In step 1615, the standby mode terminates and each block is configured so that a signal can be received from the stations 1002 and 1003 using the wireless LAN signal, and each block is configured so that information other than information related to the standby state can be transmitted from the stations 1002 and 1003. Subsequently, in step 1616, the signal received in step 1614 is processed to be handled as normal reception data, and the standby mode terminates.

In order to perform each operation related to the standby mode described in the previous description, the access point 1001 may include information relating to the operation of the standby mode in information included in a beacon that is periodically transmitted and information transmitted from the access point 1001 to the stations 1002 and 1003 during an association process used by the stations 1002 and 1003 to connect to the access point 1001. Also, in information transmitted by the stations 1002 and 1003 to the access point 1001 during the association process, the information regarding the operation of the standby mode may be included. For example, the information transmitted from the stations 1002 and 1003 may include supporting/non-supporting information of the standby mode, MCS information of the WU radio signal receivable in the standby mode, information relating to an interval of receiving the WU radio signal, information for configuring which bands is used for the WU radio signal with respect to the band of the wireless LAN signal, and the like. Furthermore, information relating to the value used as the terminal identifier, information relating to the time and interval for transmitting the WU radio signal, and information relating to the power and band used at the time of transmitting the WU radio signal may be included in the information transmitted from the access point 1001 to the stations 1002 and 1003. An example of this information relating to the power and band will be described below.

In a case that the L-part 1401 and the WUR-part 1402 illustrated in FIG. 14(a) are used at the time of transmitting the WU radio signal, due to a legal regulation or the like, the total power and power density per band of each of the L-part 1401 and the WUR-part 1042 are changed in some cases. In such a case, problems may arise in automatic gain control (AGC) of the reception RF unit 1311 at the time of receiving the WU radio signal. For example, in a case that the L-part 1401 is assumed to be 20 MHz in band and 200 mW in total power and the WUR-part 1402 is assumed to be 4 MHz in band and 200 mW in total power, the power density of the L-part 1401 per 1 MHz is 10 mW/MHz, and the power density of the WUR-part 1402 per 1 MHz is 50 mW/MHz. Additionally, in a case that the L-part 1401 is assumed to be 20 MHz in band and 200 mW in total power and the WUR-part 1402 is assumed to be 4 MHz in band and 40 mW in total power, the power density of the L-part 1401 per 1 MHz is 10 mW/MHz, and the power density of the WUR-part 1402 per 1 MHz is 10 mW/MHz. In the former case, in a case that a band of a feedback signal utilized by the AGC at the time of receiving the WU radio signal is assumed to be 4 MHz of the WUR-part 1402, the power of the feedback signal varies greatly between the L-part 1401 and the WUR-part 1402, and in the latter case, in a case that the band of the feedback signal is assumed to be 20 MHz of the L-part 1401, the signal power of the WUR-part 1402 output to the subsequent stage is reduced. In other words, it is necessary to change the operation configuration of the reception RF unit 1311 depending on the band and power of each of the L-part 1401 and the WUR-part 1402. In order to change this configuration of the reception RF unit 1311, the LPF unit 1320, the envelope detection unit 1321, or the like, the stations 1002 and 1003 may be notified of information regarding the power and band used at the time of the access point 1001 transmitting the WU radio signal. This information may include one or more kinds of information relating to the signal band, total power, and power density of the L-part 1401. Additionally, one or more kinds of information relating to the signal band, total power, and power density of the WUR-part 1402 may be included. Additionally, for the total power or power density, information relating to a ratio between the L-part 1401 and the WUR-part 1402 may be included.

Prior to the stations 1002 and 1003 receiving information relating to the signal band, total power, and power density of the WUR-part 1402 from the access point 1001, information relating to at least any one of the signal band, total power, and power density of the WUR-part 1402 that can be received by the stations 1002 and 1003 may be transmitted from the stations 1002 and 1003 to the access point. The access point 1001 may determine, in consideration of this information regarding at least any one of the signal band, total power, and power density of the WUR-part 1402 transmitted from the stations 1002 and 1003, the signal band, total power, power density, and the like of the WUR-part 1402, and notify the stations 1002 and 1003 of information including one or more kinds of information relating to the signal band, total power, and power density.

The access point 1001 may configure such that the bands of the L-part 1401 and the WUR-part 1402 of the WU radio signal to be transmitted to the stations 1002 and 1003 can be changed. For example, the signal bandwidth of the L-part 1401 may be configured such that any one of 20 MHz, 40 MHz, and 80 MHz can be selected. Additionally, the signal bandwidth of the WUR-part 1402 may be configured such that any one of 2 MHz, 4 MHz, 8 MHz, and 16 MHz can be selected.

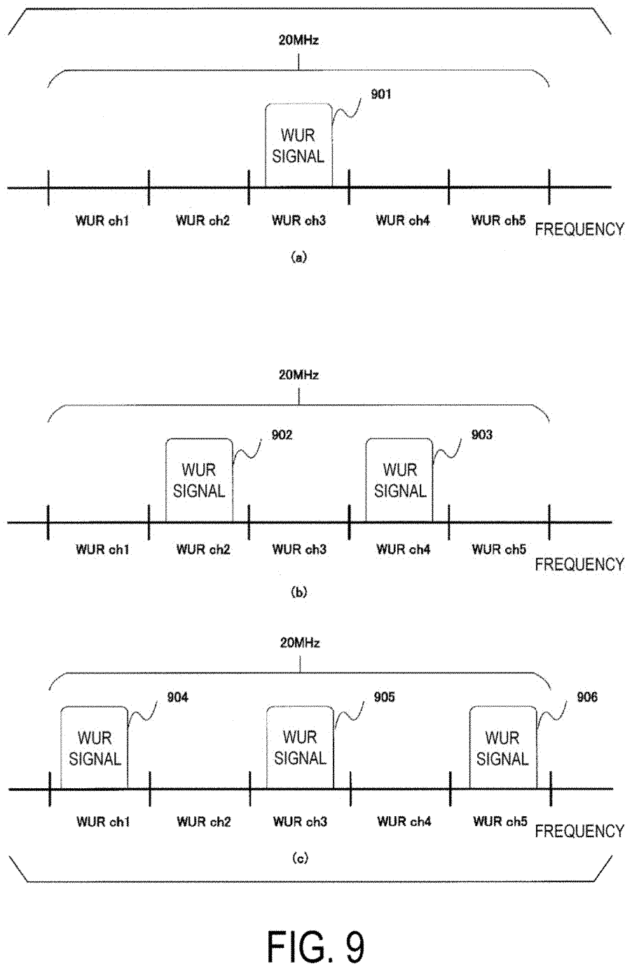

Although the description has already been given that the same value can be assigned to the terminal identifier field 1503 for the multiple stations, in order to reduce the possibility that the multiple stations to which the same value of the terminal identifier field 1503 is assigned simultaneously receive the WU radio signal to which the assigned value of the terminal identifier fields 1503 is configured, the assignment of bands in which the WU radio signal is transmitted may be changed in the bands of the wireless LAN signal. This will be described with reference to FIG. 9. As an example, an example is described in which a band of the wireless LAN signal is taken as 20 MHz, a band of the WU radio signal is taken as 4 MHz, and the WU radio signal is transmitted in each band obtained by dividing the band of the wireless LAN signal into five equal bands. These bands obtained by dividing into five equal bands are taken as WU radio channels, and are taken as a WU radio channel 1, a WU radio channel 2, a WU radio channel 3, a WU radio channel 4, and a WU radio channel 5 in order from a lower side in the band of wireless LAN signal. Allocating the WU radio channels in this manner allows the center frequency of the WU radio channel 3 to be equal to the center frequency of the wireless LAN signal, and makes it possible to assign the WU radio channel 3 to a station in which the multiple WU radio signal channels cannot be configured within the frequency band of the wireless LAN signal. FIG. 9(a) illustrates a schematic view of a case in which a WU radio signal 901 is assigned to the WU radio channel 3. This state is equivalent to the WU radio signal illustrated in FIG. 14 and the WU radio signal 901 can be received by a station using the configuration of FIG. 13 described above.

Next, as an example, FIG. 9(b) illustrates a schematic view of a case in which the WU radio channel 2 is used in a case that a WU radio signal 902 is transmitted to the station 1002 and the WU radio channel 4 is used in a case that a WU radio signal 903 is transmitted to the station 1003. The station may transmit the WU radio signal 902 and the WU radio signal 903 one by one or may transmit at the same time. Each of the stations 1002 and 1003 changes the configuration of the reception RF unit 1311 at the time of shifting to the standby mode and changes beforehand a frequency to be received to the WU radio channel that is assigned, and changes the configuration of the reception RF unit 1311 at the time of returning from the standby mode and receives the original frequency. Largely depending on properties of the reception RF unit 1311 and the LPF unit 1320 used in a case that the stations 1002 and 1003 receive the WU radio signal, in a case of simultaneously transmitting the WU radio signal 902 and the WU radio signal 903 and in a case that the stations 1002 and 1003 do the WU radio signals of the WU radio channels that are assigned thereto, respectively, there is a possibility of reception of disturbance from a signal of an adjacent WU radio channel. To avoid this disturbance from the adjacent WU radio channel, the interval of the WU radio channels that is assigned by the access point 1001 may be spoken. FIG. 9(b) illustrates a case that an unused WU radio channel (WUR ch3) is provided between the two WU radio channels (WUR ch2 and WUR ch4) that are assigned. To help determination of this interval, information relating to performance of rejecting the adjacent WU radio channel may be transmitted from the stations 1002 and 1003 to the access point 1001. The number of WU radio signals that the access point 1001 transmits at a time is not limited to two, and a number greater than two may be used. FIG. 9(c) illustrates an example of a WU radio channel assignment in which three WU radio signals can be simultaneously transmitted. In addition, in FIG. 9, a channel allocation in which the WU radio channels do not overlap is illustrated, but the WU radio channels may be allowed to overlap, and the frequency at which the WU radio signal is allocated may be increased.

In a case of transmitting multiple WU radio signals, due to limitation on transmit power of the access point 1001 and a legal regulation, it is necessary in some cases to reduce the power of the WU radio signal per one signal as compared to a case of transmitting only one WU radio signal. In such a case, the transmit power at the time of transmitting the multiple WU radio signals may be applied to the case of transmitting only one WU radio signal. In a case that the access point 1001 transmits information relating to at least any one of the signal band, the total power, and the power density of the WU radio signal to the stations 1002 and 1003, a value based on the transmission power at the time of transmitting the multiple WU radio signals may be used.

Note that the frequency position that is configured by the access point 1001 to the WUR-part 1402 is not limited to any specific one. Incidentally, depending on a communication standard, a candidate for a frequency position to which a transmitter can allocate a transmission frame is defined in some cases. For example, in the IEEE 802.11ax standard, frequency resource division (Resource unit location) as illustrated in FIG. 4 has been discussed as an example. According to the frequency resource division method illustrated in FIG. 4, the communication bandwidth of 20 MHz is divided into nine Resource units (RUs) having the same bandwidth in the resource division example 1. However, since the central RU includes a DC subcarrier, a signal mapped on the RU is further divided into two parts. Additionally, in the resource division example 2, division into five RUs in total, which includes four RUs having the same bandwidth and an RU having a half bandwidth of the RU, is performed. Note that although not illustrated in FIG. 4, a guard band can be configured between the RU and the RU in order to prevent interference between the RUs. For example, a radio transmission apparatus conforming to the IEEE 802.11ax standard can transmit at least a portion of the frame using a selected RU or an RU configured from another apparatus. By utilizing this, the radio transmission apparatus can participate in uplink frequency division multiplexing access. This suggests that there is a time period, in the frame transmitted by the radio transmission apparatus, in which the entire communication bandwidth (the entire bandwidth of 20 MHz according to the example of FIG. 4) is not necessarily occupied.

The frequency position that is configured by the access point 1001 according to the present embodiment to the WUR-part 1402 can be allocated to any of the candidates for the frequency position defined by another communication standard. For example, the access point 1001 according to the present embodiment can allocate the WUR-part 1402 to any one of the RUs illustrated in FIG. 4. With such a configuration, for example, in a case that the uplink frequency division multiplexing access is operated in accordance with the IEEE 802.11ax standard in another BSS, the access point 1001 can configure the WUR-part 1402 at a frequency position where the effect of the interference between the BSSs can be reduced. Note that the frequency position at which the access point 1001 configures the WUR-part 1402 can also be determined based on station Capabilities. For example, in a case that the access point 1001 grasps that the station can recognize a frequency resource division of the IEEE 802.11ax, the access point 1001 can allocate the WUR-part 1402 to any one of the RUs illustrated in FIG. 4. Note that in a case that the bandwidth of the RU where the access point 1001 tries to allocate the WUR-part 1402 is greater than the bandwidth of the WUR-part 1402, the access point 1001 can allocate the WUR-part 1402 at the center of the RU. On the other hand, in a case that the access point 1001 cannot grasp that the station can recognize a frequency resource division of the IEEE 802.11ax, the access point 1001 can allocate the WUR-part 1402 at the center of the 20 MHz bandwidth in which the L-part is transmitted.

Operating as described above makes it possible to release the station that has shifted to the standby state from the standby state by the access point. It is also possible, in the station, to reduce the power required to receive the WU radio signal to be received in the standby state.

### Second Embodiment

In the present embodiment, the access point 1001 transmits the WU radio frame to multiple stations exceeding one (e.g., the stations 1002 and station 1003 ). The access point 1001 can transmit the WU radio frame by using the WU radio frame as any frame of a broadcast frame, a multicast frame, and a group cast frame, in order to transmit the WU radio frame to the multiple stations. In the following, descriptions will be given assuming that the frame transmitted by the access point 1001 addressed to multiple stations is the multicast frame, but unless otherwise described, the same applies to a case that the access point 1001 transmits the WU radio frame as the broadcast frame and the group cast frame.

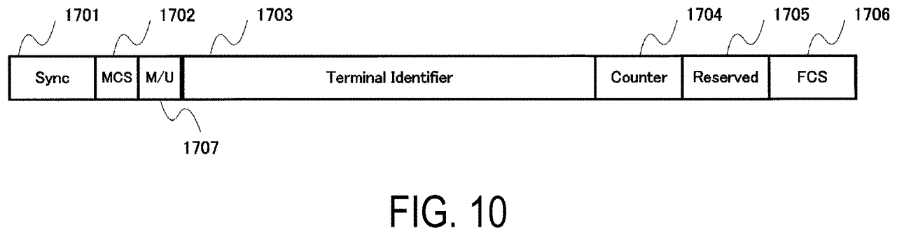

FIG. 10 is a schematic diagram illustrating an overview of a WU radio frame structure according to the present embodiment. As illustrated in FIG. 10, the WU radio frame according to the present embodiment can include multiple fields including at least any one of a synchronization part (preamble) 1701, an MCS field 1702, a multicast identification field 1707, a terminal identifier field 1703, a counter field 1704, a reservation field 1705, and an FCS field 1706. Note that the WU radio frame according to the present embodiment may include a bit field other than the fields illustrated in FIG. 10. Additionally, the order of the bit fields included in the WU radio frame according to the present embodiment is not limited to the example illustrated in FIG. 10.

The synchronization part 1701 is a synchronization part for use in synchronization, and includes the prescribed number and values of OOK modulation symbols.

The MCS field 1702 is a field indicating the MCS of a subsequent modulation symbol, and for example, indicates a case that the OOK modulation with no code is used using OOK modulation symbols with an allocation order of 1 and 0, and indicates a case that the OOK modulation using the Manchester code is used using OOK modulation symbols with an allocation order of 0 and 1.

The multicast identification field 1707 includes information written therein indicating whether the WU radio frame is a frame destined for a single station (unicast frame) or a frame destined for multiple stations (multicast frame). For example, the station that receives the WU radio frame can determine that, in a case that the multicast identification field is configured to ‘1’, the WU radio frame is the unicast frame, and in a case that the multicast identification field is configured to ‘0’, the WU radio frame is the multicast frame. Note that by extending the size of the multicast identification field 1707 to two bits, the access point 1001 can also configure so as to indicate that the WU radio frame is which one out of the unicast frame, the multicast frame, the broadcast frame, and the group cast frame.

Note that by making it possible to configure multiple codes in the synchronization part 1701, the access point 1001 can configure the WU radio frame to any one of the unicast frame and the multicast frame. For example, the access point 1001 prepares two types of codes “1010” and “1001” as configurable codes for the synchronization part 1701, in a case that the WU radio frame to be transmitted is the unicast frame, can configure “1010” to the synchronization part 1701, and in a case that the WU radio frame to be transmitted is the multicast frame, can configure the code (e.g. “1001”) different from the code configured in a case of transmitting as the unicast frame, to the synchronization part 1701. The access point 1001 configures the synchronization part 1701 in this manner, whereby the station that has received the WU frame can recognize whether the WU frame is the unicast frame or the multicast frame by performing synchronization processing on the synchronization part 1701 using different codes multiple times and acquiring a code used in a case that the synchronization can be established. In this case, the access point 1001 can transmit the WU radio frame in which the multicast identification field 1707 is omitted.

The terminal identifier field 1703 includes information used to identify both or one of the access point transmitting the WU radio signal and the station receiving the WU radio signal. The access point 1001 according to the present embodiment can configure an identifier indicating multiple stations as information written in the terminal identifier field 1703. For example, the access point 1001 can configure multiple station groups including stations managed by the apparatus itself. Here, a combination of the stations included in each station group can be different for each station group. Additionally, the number of stations included in the station group may be one or plural. Additionally, the access point 1001 can also configure a station group including a station other than the station managed by the apparatus itself. Examples of the station, which is configured to the station group, other than the station managed by the access point 1001 include a station that was configured once under the management of the access point 1001, but has been separated from the management of the access point 1001 due to degradation in communication quality or temporary handover.

The access point 1001 can configure different identifiers for the station groups, respectively. As an identifier configuration method, the access point 1001 can use the BSS color, the AID, and the Partial AID in the same manner as in the first embodiment. For example, the access point 1001 can configure a Partial AID to be assigned to the station group from a sequence except for the Partial AID assigned to each station, among configurable Partial AIDs. Hereinafter, the identification information assigned to the station group by the access point 1001 is also referred to as a multicast identifier (multicast ID). That is, it is indicated that there is a possibility that the WU radio frame to which the multicast ID is configured is a frame destined for the multiple stations. Note that by limiting the number of stations included in the station group to two or more, the WU radio frame to which the multicast ID is configured can be recognized as a frame destined for the multiple stations.

The access point 1001 can notify the station, by using a management frame, a control frame, and a data frame to be transmitted as the wireless LAN signal, of information indicating the station group and the identifier associated with the station group. In addition, the access point 1001 can notify the station of information indicating one or both of a candidate value usable as the unicast frame and a candidate value usable as the multicast frame among candidates for the identifier used by the apparatus itself. By controlling as described above, by reading the terminal identifier field 1703 of the received WU radio frame, the station can recognize whether or not the WU radio frame is the multicast frame.

The counter field 1704 can be used for retry processing or reconnection processing, but the access point 1001 according to the present embodiment can use the counter field 1704, in a case of transmitting the WU radio frame as the multicast frame, for a different purpose (described in detail below) as that in a case of transmitting the WU radio frame as the unicast frame.

The reservation field 1705 and the FCS field 1706 are used in the same manner as the reservation field 1505 and the FCS field 1506 according to the first embodiment, and thus descriptions thereof are omitted.

The access point 1001 according to the present embodiment can transmit the WU radio frame multiple times in a case of transmitting the WU radio frame as the multicast frame. This is because error correction by normal retransmission processing is difficult since the multicast frame is a frame destined for multiple stations. In a case that the access point 1001 transmits the WU radio frame as the multicast frame, by transmitting multiple WU radio frames beforehand, it is possible to reduce the probability of a frame reception error at each station that is the reception apparatus.

The method by which the access point 1001 according to the present embodiment transmits the WU radio frame multiple times is not limited to any specific one. For example, in a case of transmitting the multiple WU radio frames, the access point 1001 can perform the transmission after performing the carrier sense every time. In this case, the access point 1001 can determine whether or not to further transmit the WU radio frame, depending on a response of each station for each WU radio frame. Note that a response method of the station is not limited to any specific one, and will be described in detail later.

For example, the access point 1001 can transmit the WU radio frame multiple times within a radio medium period (e.g. TXOP) secured by the carrier sense. That is, after securing the radio medium by the carrier sense, the access point 1001 can continuously transmit the WU radio frame multiple times. At this time, the access point 1001 can configure a certain frame standby period between the WU radio frames continuously transmitted. Although a length of the frame standby period is not limited to any specific one, it is preferable to configure the SIFS to avoid an interrupt of another wireless LAN apparatus. Note that the access point 1001 can transmit a frame (e.g., a CTS-to-self frame or an RTS frame) for securing the TXOP prior to transmission of the WU radio frame. The access point 1001 can write a different value in a Length field (Duration field) included in the L-part 1401 included in the WU radio frame for each WU radio frame to be transmitted multiple times. For example, the access point 1001 can configure a period, for the Length field (Duration field), from a timing of transmitting the WU radio frame including the Length field to a timing of completion of the TXOP including the WU radio frame (or a timing that the access point 1001 completes transmission of the multiple WU radio frames). That is, it means that, of the values written in the Length fields included in the multiple WU radio frames transmitted by the access point 1001, the value in the WU radio frame transmitted in the second half of the TXOP is smaller than the value in the WU radio frame transmitted in the first half of TXOP. Note that the access point 1001 can also configure the Length field (Duration field) in the WUR-part.

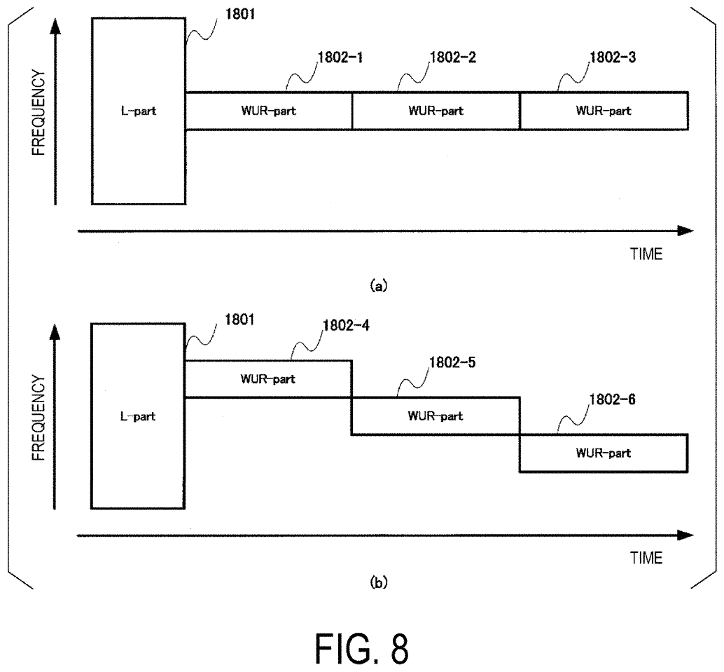

The access point 1001 can combine (aggregate) and transmit the multiple WU radio frames. FIG. 8 is a schematic diagram illustrating examples of a frame configuration of the WU radio frame according to the present embodiment. As illustrated in FIG. 8(a), the access point 1001 according to the present embodiment can aggregate and transmit multiple WUR-parts 1802-1 to 3 subsequent to the L-part 1801. In a case that the access point 1001 aggregates and transmits the WUR-parts, the numbers of fields and the contents written in the fields respectively included in the WUR-parts may be the same or different. For example, it is possible for the access point 1001 to configure the MCS field only for the first WUR-part 1802-1 and not to configure the MCS field for the subsequent WUR-parts 1802-2 to 3. Additionally, instead of aggregating WUR-parts 182 as illustrated in FIG. 8(a), the access point 1001 may aggregate only prescribed bit fields. For example, the access point 1001 can also transmit the WUR radio frame in which multiple terminal identifier fields 1703 are configured. Note that as illustrated in FIG. 8(b), the access point 1001 can also allocate the WUR-parts 1802-4 to 6 to be continuously transmitted to different frequencies, respectively, and transmit them. Note that configuring the frequencies to which the access point 1001 allocates the WUR-parts to different values for the respective WU radio frames to be continuously transmitted is possible in the same manner even in the case of performing the carrier sense for each frame transmission, or the case of continuously transmitting in the acquired TXOP, described above. Note that the transmission method of the WUR-part described above can also be configured in a case that the access point 1001 transmits the WU radio frame as the unicast frame. Additionally, the access point 1001 can also transmit the multiple WU radio frames while mixing the unicast frame and the multicast frame.

In a case that the access point 1001 transmits the multiple WU radio frames, the access point 1001 can perform different precoding for each WU radio frame. Here, the precoding includes beamforming. For example, even in a case that the access point 1001 aggregates and transmits the WUR-parts 1402, the access point 1001 can perform the different precoding on each of the aggregated WUR-parts 1402 and perform transmission. The access point 1001 can notify the station beforehand, in a case that the apparatus itself transmits the multiple WU radio frames, of whether or not to perform different precoding for each WU radio frame. Additionally, the access point 1001 can also notify the station of this by changing a signal sequence used for the synchronization part of the WUR-part 1402.

The technique, which has been described above, in which the access point 1001 continuously transmits the WU radio frame is effective to reduce the reception error of the WU radio frame transmitted as the multicast frame. However, this means that the station, which is a reception apparatus, has to maintain a reception operation state during a period in which the access point 1001 is continuously transmitting the WU radio frame, which increases the power consumption of the station.

Thus, the access point 1001 according to the present embodiment can write information indicating the number of times for continuously transmitting the WU radio frame in the counter field 1704. For example, the access point 1001 can write a numerical value indicating the number of transmission times of the WU radio frame in the counter field 1704 of the WU radio frame to be transmitted for the first time. The access point 1001 can write a value obtained by subtracting one (decremented) from the numerical value written in the counter field 1704 of the WU radio frame that has been transmitted for the first time, in the counter field 1704 of the WU radio frame to be transmitted for the second time. Thereafter, the access point 1001 can write a value obtained by subtracting one from the value written in the counter field 1704 of the WU radio frame that has been transmitted immediately before, in the counter field 1704 of the WU radio frame to be subsequently transmitted. By controlling as described above, for example, the station that has correctly received the first WU radio frame can estimate, by reading the value of the counter field 1704 of the received frame, the timing at which the access point 1001 completes the transmission of the WU radio frame, and thus can stop the reception operation until the timing. Thus, even in a case that the access point 1001 continuously transmits the multiple WU radio frames, the station can avoid an increase in the power consumption required for maintaining the reception operation.

The access point 1001 according to the present embodiment can change interpretation of each field between a case of transmitting the WU radio frame as the multicast frame and a case of transmitting it as the unicast frame. The access point 1001 can notify the station, in a case of transmitting the WU radio frame as the unicast frame, of information for identifying the station (unicast ID) by using the terminal identifier field 1703. On the other hand, the access point 1001 can notify the station, in a case of transmitting the WU radio frame as the multicast frame, of a multicast identifier and a sequence number by using the terminal identifier field 1703. Here, the sequence number can be used as information, in a case that the access point 1001 transmits the multiple WU radio frames, indicating whether the WU radio frames are the same frames or different frames. At this time, the access point 1001 can make the terminal identifier field to have a common bit size in a case that the multicast ID and the sequence number are written in the terminal identifier field 1703 and in a case that the unicast ID is written in the terminal identifier field 1703. For example, in a case that the bit size of the terminal identifier field is configured to 12 bits, the access point 1001 can write, in a case of transmitting the WU frame as the unicast frame, the unicast ID of 12 bits in the terminal identifier field 1703, and can write, in a case of transmitting the WU frame as the multicast frame, the unicast ID of 10 bits and the sequence number of 2 bits in the terminal identifier field 1703.

Note that the method in which the access point 1001 writes the multicast ID and the sequence number in the terminal identifier field 1703 is not limited to the above contents, and for example, the bit size of each of the multicast ID and the sequence number is not limited to the examples above. Also, the access point 1001 can perform joint coding on the multicast ID and the sequence number. In this case, the access point 1001 can prepare multiple multicast IDs of 12 bits specifying one station group. Different sequence numbers can be assigned to the multiple multicast IDs, respectively, that specify the same station group. In this case, by reading the multicast ID written in the terminal identifier field 1703, the station can recognize whether or not the WU radio frame is transmitted to the station group including the apparatus itself, and simultaneously also acquire the sequence number of the WU radio frame.

Even in a case that the received frame is the WU radio frame in which the multicast ID is written specifying the station group including the apparatus itself, in a case that the same sequence number is written therein as the WU radio frame, which has already been received, in which the multicast ID is written specifying the station group including the apparatus itself, the station can discard (ignore) the WU radio frame. Note that the access point 1001 can configure the numerical value written in the counter field 1704 (i.e., information indicating the number of transmission times of the WU radio frame) for each sequence number.

The station according to the present embodiment can transmit, in a case of correctly receiving the WU radio frame in which the multicast ID is written specifying the station group including the apparatus itself (i.e., in a case that, from the information written in the FCS field 1706, it can be confirmed that the WU radio frame has been able to be received without errors), a response frame indicating that the WU radio frame has been able to be correctly received to the access point 1001. The station can transmit the response frame as the wireless LAN signal.

The station according to the present embodiment can transmit a response frame to the access point 1001 based on a trigger frame transmitted from the access point 1001 after receiving the WU radio frame. In this case, the response frame transmitted by the station can be said to be a frame caused by the trigger frame transmitted by the access point 1001. In addition, in a case that the response frame transmitted by the station is the wireless LAN signal, it can be said that the response frame is a frame caused by a signal of a signal form different from the signal form of the response frame. In this case, in a case of correctly receiving the WU radio frame in which the multicast ID is written specifying the station group including the apparatus itself, it is necessary for the station to maintain a reception operation state for receiving the trigger frame expected to be transmitted from the access point 1001 until the trigger frame is received. This means that the power consumption of the station is increased.

Thus, the access point 1001 and the station according to the present embodiment can predetermine a temporal relationship between the WU radio frame and the trigger frame. For example, the access point 1001 can notify the station beforehand that the trigger frame is transmitted after the transmission of the WU radio frame that is transmitted as the multicast frame and after a certain transmission standby period terminates. The access point 1001 can notify the station of the transmission standby period by the beacon frame or the like.

In a case that the access point 1001 continuously transmits the multiple WU radio frames as the multicast frame, the access point can transmit the trigger frame after the last WU radio frame is transmitted and after the certain transmission standby period terminates. In this case, the station can obtain the number of WU radio frames transmitted by the access point 1001 based on the information written in the counter field 1704 of the WU radio frame. Thus, the station can estimate the timing at which the access point 1001 transmits the trigger frame from the number of WU radio frames, and thus can enter the reception operation state in accordance with the timing. Note that in a case that the station transmits the response frame during a period in which the access point 1001 is securing a radio medium (e.g., within the TXOP secured by the access point 1001), the station can transmit the response frame without performing the carrier sense.

On the other hand, the station according to the present embodiment can transmit the response frame to the access point 1001 without depending on the trigger frame from the access point 1001. In this case, the station performs the carrier sense after correctly receiving the WU radio frame, and can transmit the response frame in a case that the radio medium can be secured. Note that the frame that is transmitted as the response frame by the station is not limited to any specific one, for example, the station can transmit the PS-poll frame as the response frame.

According to the methods described above, the access point 1001 can efficiently transmit the WU radio frame to multiple stations while suppressing the power consumption of each station.

### Third Embodiment

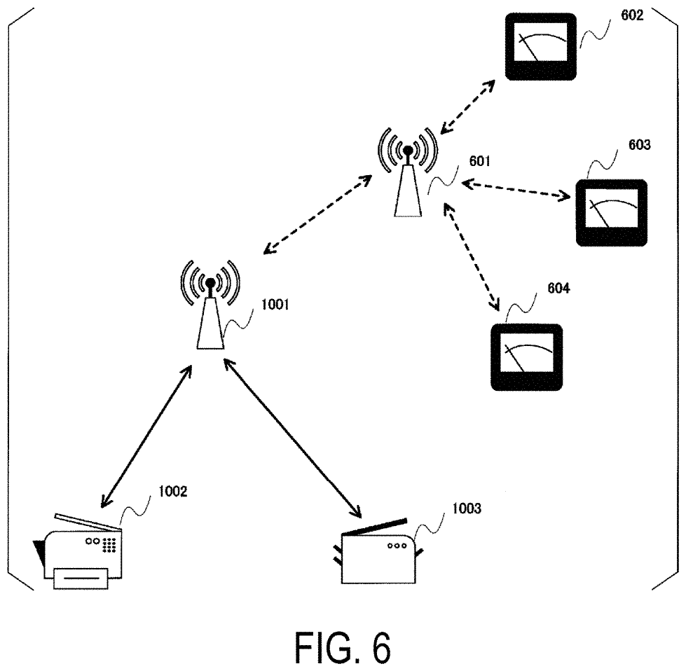

In the present embodiment, a configuration will be described in which multiple access points are provided, at least one of the access points shifts to a standby state, and is released from the standby state by the WU radio signal. FIG. 6 illustrates an example of an apparatus configuration according to the present embodiment. A reference numeral 1001, a reference numeral 1002, and a reference numeral 1003 denote an access point and stations, similar to those used in the first embodiment. A reference numeral 601 denotes an access point that can shift to the standby state, and reference numerals 602, 603, and 604 denote stations each of which performs radio communication using the wireless LAN function with the access point 601 and is available today from the standby state by the WU radio signal transmitted from the access point 601. The access point 601 does not have a distribution system DS for a wired local net, and has a function of connecting a local network of the wireless LAN including the access point 601 and the stations 602, 603, and 604 and the access point 1001. The access point 601 and the stations 602, 603, and 604 may use the configuration illustrated in FIG. 13. The local network of the wireless LAN, which includes the access point 601 and the stations 602, 603, and 604, is assumed to be included in the same subnet, and the access point 601 operates as a router in a case that an apparatus on the local network configured by the access point 1001 communicates with the stations 602, 603, and 604.

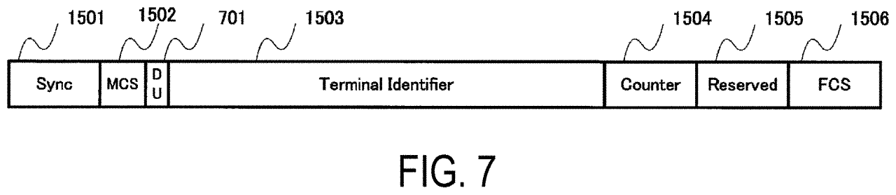

The access point 601 manages the standby state of the stations 602, 603, and 604 and also manages the standby state of the access point 601 itself. In a case that the access point 601 shifts to the standby state, the stations 602, 603, and 604 are to be shifted to the standby state beforehand. Also, in a case that a transmission request is generated from an apparatus on the local network configured by the access point 1001 to any one of the stations 602, 603, and 604 in a case that the access point 601 is in the standby state, first, the access point 1001 transmits the WU radio signal to the access point 601, wakes the access 601 up, and the woken-up access point 601 transmits the WU radio signal to the station that is the transmission request destination, whereby the target station is woken up. In this manner, in an environment in which the multiple WU radio signals are continuously transmitted, it is desirable that each station early determines a destination of the WU radio signal using the terminal identifier field 1503 in FIG. 15 so that the operation time of the demodulation unit is reduced. In particular, it is desirable for the stations 602, 603, and 604 other than the access point 601 to early stop the operation of the demodulation unit for the WU radio signal other than that addressed to themselves. For this purpose, information for identifying the WU radio signal to be used between the access points may be inserted at a temporally earlier position in the WU radio frame. A configuration example of the radio frame using this information is illustrated in FIG. 7. A reference numeral 1501 through a reference numeral 1506 are the same as those used in FIG. 15. A reference numeral 701 denotes a D/U flag of 1-bit length for identifying the WU radio signal used between the access points, in a case of 0, it is indicated that the WU radio signal is addressed to the station from the access point, and in a case of 1, it is indicated that the WU radio signal is used between the access points.

By adding the information as described above to the WU radio frame, the station in the standby state can reduce the time to operate the demodulation unit for the WU radio signal used between the access points, which makes it possible to reduce the power consumption.

### Fourth Embodiment

It may be desirable to wake an unspecified station in a standby state up in a case of approaching a specific area or a specific apparatus, at a location where an unspecified large number of apparatuses come and go. For use in such an application, a multicast address and a group-cast address for the unspecified large number of apparatuses may be predetermined. The multicast address and group-cast address for this application may be statically determined beforehand, or may be dynamically configured, by broadcast by a beacon that is periodically transmitted, by interlocking with the beacon, or by causing the station that periodically wakes up at a separately configured interval to acquire.

Operating as described above makes it possible, by the multicast address and the group-cast address for waking an unspecified station up, to wake the station up.

### Common to All Embodiments

A program running on an apparatus according to an aspect of the present invention may serve as a program that controls a Central Processing Unit (CPU) and the like to cause a computer to function in such a manner as to realize the functions of the embodiment according to the aspect of the present invention. Programs or the information handled by the programs are temporarily stored in a volatile memory such as a Random Access Memory (RAM), a non-volatile memory such as a flash memory, a Hard Disk Drive (HDD), or any other storage device system.

Note that a program for realizing the functions of the embodiment according to an aspect of the present invention may be recorded in a computer-readable recording medium. This configuration may be realized by causing a computer system to read the program recorded on the recording medium for execution. It is assumed that the “computer system” refers to a computer system built into the apparatuses, and the computer system includes an operating system and hardware components such as a peripheral device. Furthermore, the “computer-readable recording medium” may be any of a semiconductor recording medium, an optical recording medium, a magnetic recording medium, a medium dynamically retaining the program for a short time, or any other computer readable recording medium.

Furthermore, each functional block or various characteristics of the apparatuses used in the above-described embodiment may be implemented or performed on an electric circuit, for example, an integrated circuit or multiple integrated circuits. An electric circuit designed to perform the functions described in the present specification may include a general-purpose processor, a Digital Signal Processor (DSP), an Application Specific Integrated Circuit (ASIC), a Field Programmable Gate Array (FPGA), or other programmable logic devices, discrete gates or transistor logic, discrete hardware components, or a combination thereof. The general-purpose processor may be a microprocessor or may be a processor of known type, a controller, a micro-controller, or a state machine instead. The above-mentioned electric circuit may include a digital circuit, or may include an analog circuit. Furthermore, in a case that with advances in semiconductor technology, a circuit integration technology appears that replaces the present integrated circuits, one or more aspects of the present invention can use a new integrated circuit based on the technology.

Note that the invention of the present patent application is not limited to the above-described embodiments. In the embodiment, apparatuses have been described as an example, but the invention of the present application is not limited to these apparatuses, and is applicable to a terminal apparatus or a communication apparatus of a fixed-type or a stationary-type electronic apparatus installed indoors or outdoors, for example, an AV apparatus, a kitchen apparatus, a cleaning or washing machine, an air-conditioning apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

### INDUSTRIAL APPLICABILITY

One aspect of the present invention is applicable to radio communication apparatuses. An aspect of the present invention can be utilized, for example, in a communication system, communication equipment (for example, a cellular phone apparatus, a base station apparatus, a wireless LAN apparatus, or a sensor device), an integrated circuit (for example, a communication chip), or a program.

### REFERENCE SIGNS LIST

1001, 601 Access point
1002, 1003, 602, 603, 604 Station
1501, 1701 Synchronization part
1502, 1702 MCS field
701 D/U flag
1707 M/U flag
1503, 1703 Terminal identifier field
1504, 1704 Counter field
1505, 1705 Reservation field
1506, 1706 FCS field
1511 BSS color field
1512 AID field
1513 Partial AID field
1401, 1801 Legacy part
1402, 1802-1 to 1802-6 WU radio part
901 to 906 WU radio signal
1201, 1310 Preamble generation unit
1202, 1302 Transmission data control unit
1203, 1303 Mapping unit
1204, 1304 IDFT unit
1205, 1305 P/S converting unit
1206, 1306 GI addition unit
1207, 1307 D/A converting unit
1208, 1308 Transmission RF unit
1209, 1309 Antenna switching unit
1210, 1310 Antenna unit
1211, 1311 Reception RF unit
1212, 1312 A/D converting unit
1213, 1313 Symbol synchronization unit
1214, 1314 S/P converting unit
1215, 1315 DFT unit
1216, 1316 De-mapping unit
1217, 1317 Reception data control unit
1218 DS controller
1219, 1319 Controller
1318 Application IF unit
1320 LPF unit
1321 Envelope detection unit
1322 Synchronization unit
1323 Demodulation unit

1. An access point apparatus for connecting and performing radio communication with a plurality of station apparatuses, the access point apparatus comprising:
a transmission RF unit configured to transmit a wireless LAN signal and a wake-up radio signal,
wherein the wake-up radio signal includes a legacy part and a wake-up radio part,
a band of a signal of the legacy part and a band of a signal of the wake-up radio part are different from each other,
a wake-up radio frame included in the wake-up radio signal includes an identifier for indicating being multicast transmission, and
the wake-up radio signal that includes a predetermined number of the wake-up radio frames is transmitted in a radio medium time secured by a carrier sense.

2. The access point apparatus according to claim 1,
wherein a counter field is included in the wake-up radio frame,
the predetermined number is configured in the counter field at a time of initial transmission of the wake-up radio signal, and
a value of the counter field is decreased every time the wake-up radio signal is transmitted a plurality of times.

3. The access point apparatus according to claim 1,
wherein, after the wake-up radio signal that includes the predetermined number of the wake-up radio frames is transmitted, a trigger frame for causing the plurality of station apparatuses that are destinations of the multicast transmission to respond is transmitted after a first time has elapsed, and
the first time is based on the value configured in the counter field of the wake-up radio frame.

4. The access point apparatus according to claim 1,
wherein an identifier for indicating being unicast transmission is further included, or the identifier for indicating the multicast transmission indicates the unicast transmission in a case of not indicating the multicast transmission, and a length of at least one field of the counter field and another field included in the wake-up radio frame changes between a time of the unicast transmission and a time of the multicast transmission.

5. The access point apparatus according to claim 1,
wherein a sequence number is included in the wake-up radio frame transmitted by the access point apparatus.

6. A station apparatus for connecting and performing radio communication with an access point, the station apparatus comprising:
a reception RF unit configured to receive a wireless LAN signal and a wake-up radio signal,
wherein the wake-up radio signal includes a legacy part and a wake-up radio part,
a band of a signal of the legacy part and a band of a signal of the wake-up radio part are different from each other,
the wake-up radio signal includes a wake-up radio frame,
the wake-up radio frame includes an identifier for indicating being multicast transmission, and
in a case that the wake-up radio frame that indicates being the multicast transmission by using the identifier for indicating being the multicast transmission is received, a trigger frame is transmitted to the access point at a first time indicated by a value of a counter frame included in the wake-up radio frame,.

7. The station apparatus according to claim 6,
wherein the wake-up radio frame that is received includes a sequence number, and
in a case of receiving the wake-up radio frame that includes a sequence number that overlaps with a sequence number included in the wake-up radio frame that is previously received, the wake-up radio frame configured to include the sequence number that overlaps is discarded.

8. The station apparatus according to claim 6,
wherein a field length of a counter field and another field included in each of the wake-up radio frame that indicates being the multicast transmission and the wake-up radio frame that does not indicate being the multicast transmission, by using the identifier for indicating being the multicast transmission, changes between a time of the multicast transmission and a time of transmission other than the multicast transmission.

9.-15. (canceled)
